(19) United States
(12) Patent Application Publication
(10) Pub. No.: US 2022/0279710 A1
(43) Pub. Date: Sep. 8, 2022

(54) AGRICULTURE MACHINE ASSEMBLY

(71) Applicant: CLAAS Tractor SAS, Vélizy-Villacoublay Cedex (FR)

(72) Inventors: Jan Carsten Wieckhorst, Uelzen Ortsteil Hanstedt (DE); Christian Ehlert, Bielefeld (DE); Christian Birkmann, Versmold (DE); Jona Carsten Pieper, Nordkirchen (DE); Martin Ober, Trichtingen (DE); Sascha Pflanze, Bad Saulgau (DE); Pierre Noyer, Osnabrück (DE); Martin Göldner, Schwenningen (DE); Michael Fugunt, Bad Wurzach (DE)

(73) Assignee: CLAAS Tractor SAS, Vélizy-Villacoublay Cedex (FR)

(21) Appl. No.: 17/688,345

(22) Filed: Mar. 7, 2022

(30) Foreign Application Priority Data
Mar. 8, 2021 (DE) 102021105548.2

(51) Int. Cl. A01D 34/00; A01D 34/412

(52) U.S. Cl. CPC A01D 34/008; A01D 34/412; A01D 2101/00

(57) ABSTRACT

An agriculture machine assembly working in combination with an agricultural work machine and a disk mower adapted to the agricultural work machine is disclosed. The agriculture machine assembly comprises a driver assistance system that optimizes operation and includes a computing unit and an operating and display unit. One or both of the agricultural work machine or the disk mower include at least one control device for controlling and regulating one or both of the agricultural work machine or the disk mower. The driver assistance system is structured such that it forms a work machine setting device and a disk mower setting device, which optimize the operation of the agricultural work machine and the disk mower depending on each other.

### CROSS REFERENCE TO RELATED APPLICATION

This application claims priority under 35 U.S.C. § 119 to German Patent Application No. DE 102021105548.2 filed Mar. 8, 2021, the entire disclosure of which is hereby incorporated by reference herein.

### TECHNICAL FIELD

The present invention relates to an agriculture machine assembly for use as part of or with one or more agricultural work machines and one or more attachments configured to work with an agricultural work machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

EP 2 769 613 B1 describes a mower assembly comprising (or consisting of) a carrier vehicle and one front mower and two rear mowers, the operation of which may be regulated by a control apparatus. The control apparatus may be configured to automatically ascertain operating parameters for operating the mowers depending on a slope, which may be determined by one or more sensors, on which the work assembly is being operated.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 shows a plan view of a machine assembly consisting of a work machine and at least one attachment adapted to the agricultural work machine;

FIG. 2 shows a schematic representation of the agriculture machine assembly with a driver assistance system;

FIG. 3 shows a schematic view of a structure of a setting device of the agriculture machine assembly;

FIG. 4 shows a schematic representation of the driver assistance system;

FIG. 5 shows a flowchart for illustrating the mode of operation of the driver assistance system; and

FIG. 6 to FIG. 30 show schematic and exemplary representations of the menu guidance and operating approach of the driver assistance system.

### DETAILED DESCRIPTION

An agriculture machine assembly may comprise (or consist of) at least one agricultural work machine that has controllable work aggregates to adjust the setting parameters of the agricultural work machine, and at least one attachment configured to the agricultural work machine that has an interface for adapting to and communicating with the agricultural work machine. Work aggregates of the agricultural work machine may be, for example, a drive motor for driving, a gearbox, and/or one or more power takeoffs for driving the adapted attachment. The agriculture machine assembly may comprise a driver assistance system that improves or optimizes operation and have a computing unit and at least one operating and display unit. Further, the computing unit may be configured to process information generated by any one, any combination, or all of: machine-internal sensor systems (e.g., the information is generated by machine-internal sensor system(s) that are resident on the at least one agricultural work machine); external information (e.g., the external information is generated external to the at least one agricultural work machine); and information that may be saved in the memory unit. Moreover, the agricultural work machine and/or the at least one attachment comprise at least one control device for controlling and regulating the agricultural work machine and/or the attachment. The term “setting parameter” may be understood broadly and may comprise one or more operating parameters such as any one, any combination, or all of: a drive rotational speed; a hydraulic or pneumatic pressure or the like; or machine parameters like distance, number and the like.

The setting of the agricultural work machine and attachment of an agriculture machine assembly may be a complex process that requires detailed knowledge by an operator of both the agricultural work machine and the particular attachment to be adapted. Moreover, the operator may need to have agricultural knowledge in order to be able to estimate the effects of settings. The setting parameters of the agricultural work machine and attachment may mutually influence each other. When incorrect settings are selected, the result of work, the quality of work, the achievable output per area, or the efficiency such as fuel consumption may be negatively affected. For economic operation of such an agriculture machine assembly, it is important for the agriculture machine assembly to be operated efficiently (e.g., as efficiently as possible). The number of different agricultural work machines (e.g., tractors) and the number of different potential attachments within a particular category may make it difficult for an operator to adjust the setting parameters of the devices belonging to the agriculture machine assembly in such a manner, and to adapt them to the particular operating situation influenced by the environmental and harvesting or working conditions, to enable optimum operation of the agriculture machine assembly.

Thus, one object comprises a machine assembly that is configured to more easily and has the ability to adjust setting parameters that better considers the complex relationships for achieving improved or optimized operation of the agriculture machine assembly during an existing or changing operating situation.

In one or some embodiments, an agriculture machine assembly is disclosed comprising (or consisting) of at least one agricultural work machine that has controllable work aggregates for adjusting setting parameters of the agricultural work machine, and at least one attachment adapted or configured to work with the agricultural work machine that has an interface for adapting to or communicating with the agricultural work machine. The agriculture machine assembly comprises a driver assistance system that controls (e.g., improves or optimizes) operation and which has a computing unit and at least one operating and display unit. The computing unit is configured to process information generated by machine-internal sensor systems, external information and information that may be saved in the computing unit. The agricultural work machine and/or the at least one attachment may comprise at least one control device for controlling and regulating the agricultural work machine and/or the attachment. The at least one attachment may comprise a disk mower, with the driver assistance system being structured so that it forms a work machine setting device and a disk mower setting device. The particular setting devices may produce an optimization of the operation of the agricultural work machine and the at least one disk mower depending on each other. For example, the agricultural work machine setting device and the disk mower setting device may be configured to control operation of the at one agricultural work machine to generate a controlled state of the agricultural work machine and to control operation of the disk mower to generate a controlled state of the disk mower such that the controlled operation to generate the controlled state of the at least one agricultural work machine and the controlled state of the disk mower are selected in combination and dependent on one another. In one or some embodiments, the associated state of the agricultural work machine and the disk mower may be based on one or more parameters, as discussed in more detail below. In this way, the structured driver assistance system may result in harmonized control (e.g., optimized control) of setting parameters of the agricultural work machine and the disk mower adapted thereto, which may make the operation of the agricultural machine system assembly (e.g., the combination of the agricultural work machine and the disk mower) more efficient. The driver assistance system may therefore produce an improved or optimized adaptation of the setting parameters to a given operating situation in order to effectively and optimally configure the operation of the agriculture machine assembly. In particular, the complex process of adjusting the agriculture machine assembly may be simplified, which may prevent incorrect settings by an operator.

In one or some embodiments, the agricultural work machine may comprise a tractor. Work aggregates of the agricultural work machine may comprise any one, any combination, or all of: a drive motor (e.g., that may be designed as an internal combustion engine); a gearbox (e.g., a gearbox that is shiftable or continuously variable under a full or partial load); a power take-off (e.g., a PTO shaft); a hitch; a hydraulic system; or other actuators or work machines that may influence the operation of the agriculture machine assembly.

In one or some embodiments, the agricultural work machine setting device and the disk mower setting device form a common setting device. Accordingly, the agricultural work machine setting device and the disk mower setting device may be centrally operated and controlled by the driver assistance system to improve or optimize the operation of the machine assembly having a complex structure, such as, for example, an arrangement of several disk mowers to be driven and controlled in the front, rear and/or side areas of the tractor.

Thus, the driver assistance system may comprise a common set of rules, or a set of rules assigned to the agricultural work machine setting device and the disk mower setting device that produce an improvement or an optimization of the mode of operation of the agriculture machine assembly. In practice, the common setting device, using the common set of rules, may be configured to determine the controlled operation for generating the controlled state of the at least one agricultural work machine and the controlled state of the disk mower.

In one or some embodiments, the agricultural work machine and/or the at least one disk mower adapted thereto may comprise at least one control device designed as an ISO-based control device that forms part of the agricultural work machine setting device, and/or the disk mower setting device. By standardizing the communication between the agricultural work machine and the at least one disk mower, such as from different manufacturers, using the so-called ISO bus, their operation (e.g., setting and control) may be simplified.

Alternatively or in addition, the control device of the at least one disk mower may be designed as a separate terminal or as a hydraulic valve assembly of the agricultural work machine that forms a part of the agricultural work machine setting device, and/or the disk mower setting device. Thus, as separate devices, the agricultural work machine setting device may include an agricultural work machine set of rules to determine the controlled operation for generating the controlled state of the at least one agricultural work machine and the disk mower setting device may include a disk mower set of rules to determine the controlled operation for generating the controlled state of the disk mower.

In one or some embodiments, the driver assistance system may be configured to control the at least one disk mower via a control apparatus designed as a job computer and assigned to the disk mower. Merely by way of example, the driver assistance system may be configured to control the disk mower by sending one or more commands to the control apparatus. In turn, the control apparatus may execute the commands to control the disk mower.

In particular, the driver assistance system may comprise selectable strategies (e.g., potential strategies) for improving or optimizing the operation of the agriculture machine assembly. Even before the actual improvement or optimization begins, this allows specifying the prioritized target setting with which an operator wants to operate the agriculture machine assembly. The selectable strategies may be any one, any combination, or all of work machine-specific strategies, disk mower-specific strategies, or a combination of both. The improvement or optimization of the mode of operation of the agriculture machine assembly may be based on technical and agronomic knowledge combined with each other. The technical and agronomic knowledge may be saved or manifested as a set of rules.

In one or some embodiments, the selectable strategies may at least comprise any one, any combination, or all of the strategies of “efficiency”, “performance”, “quality”, “soil protection”, “cost” or “user-defined”. The strategy of “efficiency” as an optimization goal may be based on any one, any combination, or all of the reduction of fuel consumption; the reduction of the operating hours of the agriculture machine assembly for processing a work order; the minimization of wear; or the minimization of the required time for performing headland maneuvers. The strategy of “efficiency” may also include the duration of drying the mowed harvested material that may be influenced by the use of roller conditioners as additional equipment to the disk mower. The strategy of “efficiency” may be particularly oriented around the maximum achievable output per area, and/or the increase in the operating hours of the agriculture machine assembly. With the strategy of “quality”, the focus may be on the work quality achievable by the at least one disk mower from optimized setting parameters. This may include, for example, a minimization of the proportion of crude ash and the maintenance of a minimum mowing height to ensure the subsequent growth of forage plants, such as to minimize the spread of weeds that displace the subsequently growing forage plants. Another aspect that be considered for the strategy of “quality” is the quality of the preparation of leaf-rich types of forage, the even spreading width of the mown harvested material over the work width of the disk mower, and/or the swath deposit. With the optimization strategy of “soil protection”, the goal of minimizing soil pressure and/or soil compaction caused by the agriculture machine assembly may be achieved, and/or the traction behavior may be improved or optimized. With the strategy of “cost”, for example the cost per area (€/hectare) may be optimized considering any one, any combination, or all of the fuel, wage, or machine costs. The strategy of “user-defined” makes it possible for the operator to at least partially link the available strategies to each other with variable proportions (e.g., a plurality of strategies as disclosed above may be weighted as an indication of importance).

In one or some embodiments, the driver assistance system may be configured for a dialog-based determination of setting parameters that may be used to improve or optimize the mode of operation of the agriculture machine assembly. The determination of at least part of the setting parameters may occur before starting up the agriculture machine assembly and/or the initiation of an agricultural work procedure by the agriculture machine assembly, such as a mowing process, by the driver assistance system. This makes it possible to consider that some of the settings to be made may be made independently of the prevailing conditions on the field to be worked. The dialog-based determination of setting parameters may be performed in natural language (e.g., by a dialog specified and carried out by the driver assistance system). The dialog may be set up in a hierarchical fashion and may follow the top-down approach.

In one or some embodiments, the driver assistance system may comprise a “settings” module with several individual modules, such as any one, any combination, or all of “machine data”, “Basic settings”, and “Work goal”, that may be used for dialog-based input and/or specification (such as by selection) of setting parameters of the agricultural work machine and the at least one disk mower of the agriculture machine assembly. Using the “settings” module or the individual modules of “machine data”, “basic settings” and “work goal” that it comprises, basic settings of the agriculture machine assembly may be made before starting the agriculture machine assembly and/or the initiation of an agricultural work process, the execution of which may be essential to the work process, or respectively mowing process to be performed later. The individual modules of “machine data”, “basic settings” and “work goal” may be executed independently of each other. In one or some embodiments, an overview of the individual module-specific setting steps of the agriculture machine assembly may be specified by the “settings” module using any one, any combination, or all from the group of “device details”, “work conditions”, “tire setting”, “ballast recommendation”, “tire pressure recommendation”, “type of harvested material”, “preparation on the farm”, “preparation on the field”, “work strategy settings”, “device details”, “job”, “type”, “coupling point and coupling type”, “determination of weight”, and “equipping the attachment”. With this structure, a better overview of the method steps to be processed may be achieved within the “settings” module, or respectively the individual modules of “machine data”, “basic settings” and “work goal”. An operator who may be less skilled will therefore not be overwhelmed by the many setting parameters that may vary strongly due to the particular complexity of the agricultural work machine and attachment.

In one or some embodiments, at least one setting parameter to be determined for the at least one disk mower may any one, any combination, or all from the group of “type of at least one disk mower”, “position and means for arranging the at least one disk mower on the agricultural work machine”, “additional equipment on the at least one disk mower” before the agriculture machine assembly starts the agriculture machine assembly and/or initiates an agricultural work process, in particular a mowing process. Moreover, the number of disk mowers that are arranged on the agricultural work machine may also belong to the setting parameters that are to be determined before the agricultural work process (e.g., the mowing process), and may be initiated by the agriculture machine assembly. The “type of at least one disk mower” may comprise, on one hand, the indicated manufacturer and/or the type of disk mower (e.g., designed as a front disk mower, as a middle or side-mounted disk mower, rear disk mower, or as a pulled disk mower). Moreover, the type of disk mower may determine its work width. Corresponding to the type of at least one disk mower, the position of the disk mower adapted to the agricultural work machine may comprise another setting parameter that is to be determined before initiating an agricultural work process (e.g., the mowing process). This correspondingly holds true for the required correspondence of the attachment category of the agricultural work machine and the particular disk mower, or respectively the means for arranging or connecting on the agricultural work machine such as a double hood for a rear disk mower or a quick coupling for the front disk mower. Disk mowers may further have additional equipment in the form of a tine conditioner or a roller conditioner which may constitute yet another setting parameter (which may be input via dialog-based entry) for improved or optimized setting parameters to be determined by the setting device(s). The use of additional equipment may, in turn, require further settings for optimum operation of said equipment, for example setting of the roller distance and/or a spring force of the roller conditioner exerted on the roller. With additional equipment designed as a tine conditioner or roller conditioner, additionally adjustable guide plates, pivotable swathing disks and/or driven conveyor drums may be arranged on the at least one disk mower that serve to evenly distribute the mown material over the work width or improve the flow of the mown material. With disk mowers without additional equipment in the form of a tine conditioner or roller conditioner, pivotable swathing disks may be arranged on the disk mower that serve to evenly distribute the mown material over the work width. Additional equipment may also be a transverse conveyor on a disk mower that serves to form a swath.

Moreover, at least one setting parameter of the agricultural work machine to be determined before an agricultural work process (e.g., before the mowing process) may be initiated by the agriculture machine assembly, which may comprise any one, any combination, or all from the group of ballast, tire pressure, tire geometry, axle load, relief force of a relieving device, and hitch setting parameter. For this purpose, setting parameters of the agricultural work machine may be used that are manufacturer-specific for the particular work machine and may be saved in the computing unit, and/or are determined during the dialog-based entry by queries in order to be able to consider any deviations from the manufacturer-specific setting parameters that may be based on improvement or optimization proposals by the setting device of the driver assistance system.

In particular, at least one setting parameter to be determined may be any one, any combination, or all from the group of drive rotational speed of at least one driveshaft of the agricultural work machine, hitch setting parameter, type of attachment for indirect or direct adaptation, or respectively mounting of a particular disk mower on the agricultural work machine, parameter of the attachment, cutting height, relief force of a relieving device, type and control of a soil contour adaptation device, soil distance of the soil contour adaptation device and coupling distance to the agricultural work machine before the agriculture machine assembly starts the agriculture machine assembly and/or assumes an agricultural work process (e.g., the mowing process).

In one or some embodiments, device manufacturer-specific setting parameters for at least one combination of at least one disk mower and a work machine may be saved in the computing unit. In one or some embodiments, device-specific operating parameters and/or machine parameters may be retrievably saved in the computing unit for different work machines and different disk mowers of at least one manufacturer. In this manner, an especially non-editable basic configuration may be provided that may be used for improvement or optimization of the mode of operation of the particular machine assembly by the setting device, in particular as a template. In one or some embodiments, the device manufacturer-specific operating and/or setting parameters may be saved and therefore edited for the at least one combination as a personalized data set.

In one or some embodiments, the driver assistance system may be configured to determine overlapping areas of the work widths to be set depending on the type and/or the position of the arrangement of a front and at least one rear disk mower on the agricultural work machine, and a particular work width of the disk mowers. Other setting parameters may result from the overlapping area setting parameters that relate to the length of the used prop shafts or the length setting of length-adjustable prop shafts with which the particular disk mower is driven whose arrangement extends beyond the work width of a front or middle disk mower. The particular work width may be determined by the width of the mowing bar of the particular disk mower. Moreover, potential depositing strategies for the swath may result therefrom.

In one or some embodiments, the driver assistance system may be configured to save setting parameters as a common data set or separate data sets recorded by the driver assistance system based on a dialog in the context of a specific machine assembly, determined by sensors, and/or received by being transmitted from external data sources, and the data set or the data sets that are assigned to the particular, specific machine assembly may be repeatedly retrieved and edited. Such a data set may, for example, be individually assigned to a specific machine assembly consisting of the agricultural work machine and disk mower or disk mowers in order to be able to access them as an editable basis for setting in a new use.

Moreover, at least one sensor system assigned to the agriculture machine assembly may be configured to autonomously determine one or more setting parameters of the agriculture machine assembly, harvested material parameters and/or environmental parameters.

In particular, the driver assistance system may be configured to receive external information in order to determine setting parameters, harvested material parameters and/or environmental parameters therefrom. To accomplish this, the driver assistance system may communicate with one or more external data sources, such as any one, any combination, or all of: a farm management system that is centrally operated on a farm or decentralized in a computer center; with third-party suppliers of data such as weather data; or with product data from manufacturers of the agricultural work machine and/or the at least one disk mower, position data, etc.

In one or some embodiments, a functional model of the agricultural work machine and the at least one disk mower may be saved in the computing unit that depicts at least part of the functional relationships of the agricultural work machine and the at least one disk mower adapted thereto. Accordingly, the various operating situations of the agricultural work machine and the at least one disk mower may be modeled using the functional model in order to achieve an optimization of the mode of operation of the agricultural work machine and the at least one disk mower in the particular operating system and taking into account the selected control strategy. Alternatively contemplated are also pure black box models that, for example, may be based on artificial intelligence (AI) or neural networks, or mixed forms in order to depict at least part of the functional relationships.

To depict the functional relationships of the agriculture machine assembly, at least one n-dimensional characteristic diagram may be assigned to at least one setting parameter of the agricultural work machine and/or the at least one disk mower, wherein the particular setting parameter is defined as an output variable of the at least one n-dimensional characteristic diagram. Using the at least one n-dimensional characteristic diagram, even complex functional relationships of a system from the agriculture machine assembly and environment may be depicted with little computing effort. Characteristic curves of the n-dimensional characteristic diagram may be adaptively adapted to the particular situation in order to holistically take into account relationships during the operation of work machines, at least one disk mower, and environmental conditions that have an influence on the control strategies. The characteristic curves of the n-dimensional characteristic diagram may be adapted by the particular setting device, the agricultural work machine setting device, and the disk mower setting device, such as by the setting device jointly formed thereby.

In one or some embodiments, the computing unit may match the at least one n-dimensional characteristic diagram during ongoing operation, such as cyclically, with the conditions of use of the agriculture machine assembly, such that at least one n-dimensional initial characteristic diagram for the at least one setting parameter is saved in the computing unit, and during an initial determination of the at least one setting parameter, the computing unit may perform the determination based on the initial characteristic diagram. In this regard, for example the data set(s) may be accessed that were saved in the computing unit at an earlier point in time of use of the active machine assembly.

In one or some embodiments, the driver assistance system may be configured to visualize, using the at least one operating and display unit, an operating process for adjusting a setting parameter to be adapted for optimizing the mode of operation of the agriculture machine assembly. To accomplish this, the component or the components for which the corresponding setting is to be implemented may also be displayed to the operator in addition to the particular value for a setting parameter determined or suggested by the driver assistance system. A part of the setting parameters may be implemented automatically or remotely, whereas a part of the setting parameters to be implemented may necessitate a manual intervention. A first example comprises adjusting hydraulic pressures, and a second example comprises adapting the length of prop shafts. The depiction of the component or the components that are to be set by manual intervention may be in the form of individual pictograms or icons, or as a sequential image sequence.

In one or some embodiments, the at least one operating and display unit of the driver assistance system may be part of a mobile data processing device. The advantage of designing at least one operating and display unit of the driver assistance system as a component of a mobile data processing device is that the operator may carry it with him when the previously determined setting parameter(s) are set, such as manually, for the agriculture machine assembly. The mobile data processing device may communicate wirelessly and/or wired with the driver assistance system. Alternatively, the at least one operating and display unit may be executed on remote control hardware, such as remote from the agricultural work machine and/or the at least one disk mower. In one or some embodiments, remote control hardware may comprise data processing hardware remote from the agriculture machine assembly, which, for example, may be a cloud-based data processing system. In principle, the data source remote from the agriculture machine assembly may also be a data server remote from the agriculture machine assembly that communicates via an Internet connection or the like with the agriculture machine assembly.

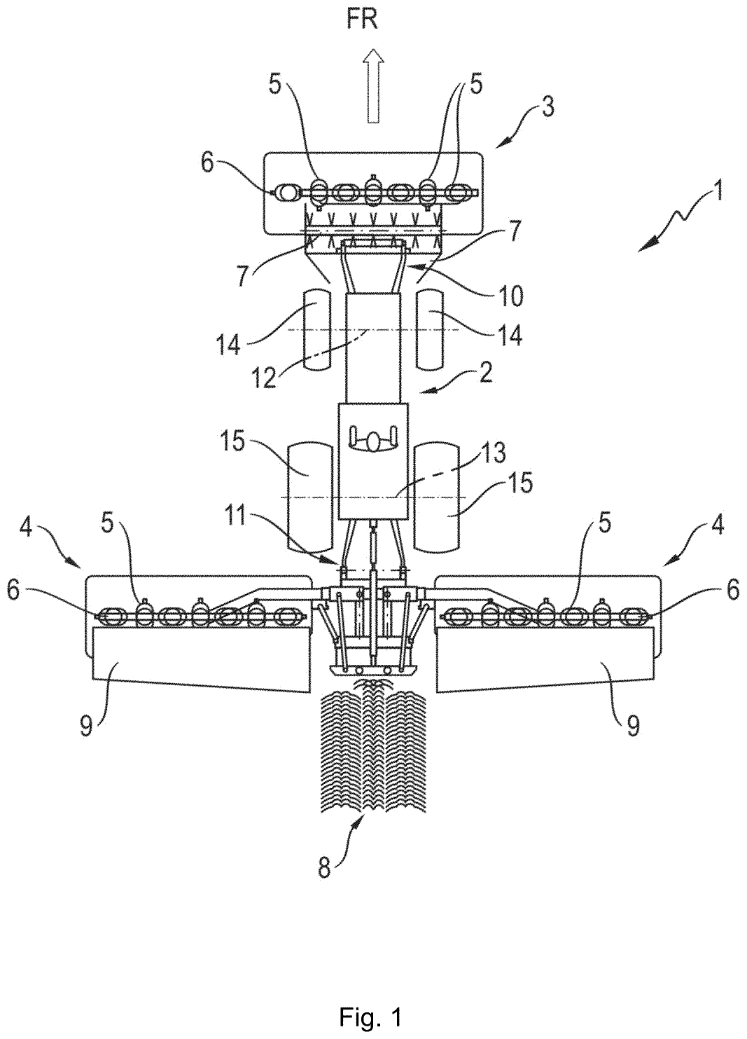

Referring to the figures, FIG. 1 shows a plan view of the agriculture machine assembly 1 comprising (or consisting) of an agricultural work machine 2 and at least one attachment adapted to or configured to interact with the agricultural work machine 2. In one or some embodiments, the agricultural work machine 2 is designed as a tractor. In one or some embodiments, the attachment in the depicted exemplary embodiment is designed as a disk mower 3 arranged or positioned on the front, that in the following will also be termed a front disk mower, and a disk mower 4 arranged or positioned in the rear area of the agricultural work machine 2, that in the following will also be termed a rear disk mower. The arrangement of one or more rear disk mowers 4 may vary with respect to their position in the rear area depending on whether the rear disk mower 4 is mounted in the middle or on the side. An arrangement of two rear disk mowers 4 is also termed a butterfly combination. Moreover, a disk mower 4 arranged in the rear area may be designed as a pulled mower with a central drawbar or a side drawbar. Each of the disk mowers 3, 4 shown in FIG. 1 has cutting units 5 for cutting harvested material, wherein the cutting units 5 are positioned next to each other viewed perpendicular to the driving direction FR while forming in each case a mowing bar 6.

In one or some embodiments, the disk mower 3 has optional additional equipment 7 that may be designed as a tine conditioner or roller conditioner. The disk mower 4 arranged on the rear may also be designed with such additional equipment 7. The rear disk mowers 4 may also be equipped with transverse conveyors 9 for swath deposition as additional equipment 7 that serve to transport the cut harvested material perpendicular to the driving direction FR. The transverse conveyors 9 may be designed as belt units or screw conveyors. Using the transverse conveyors 9, various forms of depositing a swath 8 may be achieved. To adapt the disk mowers 3, 4 to the agricultural work machine 2, the agricultural work machine 2 has a front hitch 10 and a rear hitch 11. In one or some embodiments, the hitches 10, 11 are designed as three-point hitches and are hydraulically actuated, and have adjustable upper links 11a and lower links 11b.

In one or some embodiments, the agricultural work machine 2 has a front axle 12 and a rear axle 13 with front wheels 14 and rear wheels 15 attached thereto. The front wheels 14 and rear wheels generally may vary with regard to the dimensions of their tires.

The agricultural work machine 2 has various work aggregates 34 such as, for example, a drive motor 16, a transmission 17, power take-off shafts 18, the hitches 10, 11 or a tire pressure control system. The work aggregates 34 of the agricultural work machine 2 may be controlled and regulated by a control apparatus 19 designed as a job computer. As discussed below, the control apparatus 19 may comprise computer functionality, such as at least one processor and at least one memory. The control apparatus 19 may be configured to determine and set the setting parameters of these work aggregates 34. An operating and display unit 20 that is connected to the control apparatus 19 may be arranged or positioned in a cab of the agricultural work machine 2.

The agriculture machine assembly 1 may be assigned to a driver assistance system 21 that is configured to adjust and control (e.g., optimize) the operation of the agriculture machine assembly 1 comprising (or consisting) of the agricultural work machine 2 and the at least one disk mower 3, 4. The driver assistance system 21 has a computing unit 22 and at least one operating and display unit 23.

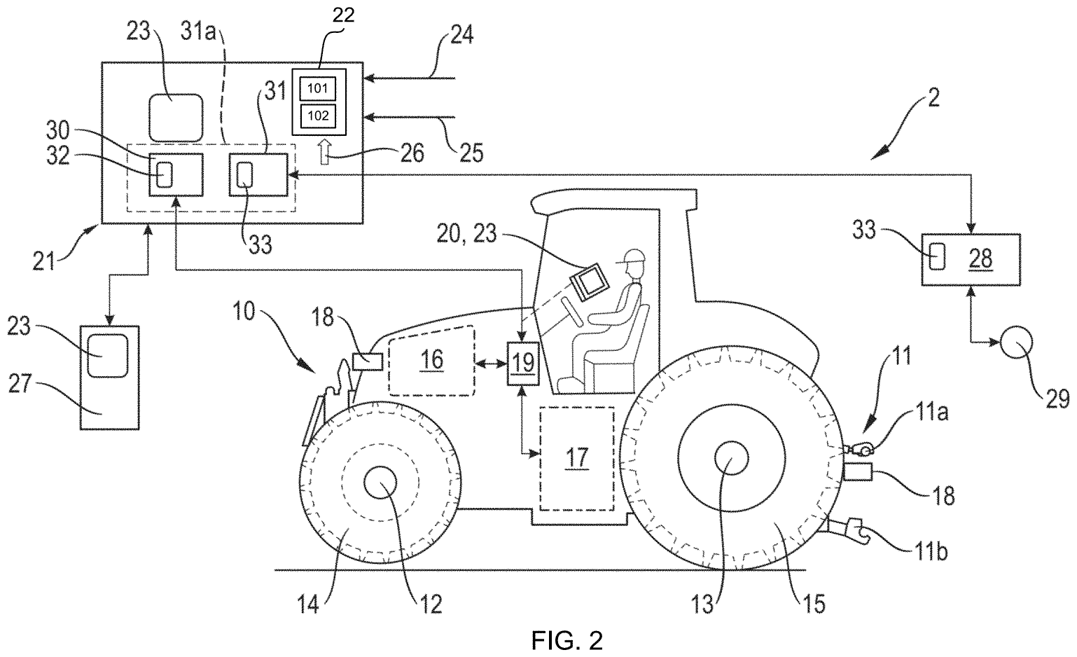

Computing unit 22 may comprise any type of computing functionality and may include at least one processor and at least one memory, which is depicted in FIG. 2 as processor 101 (which may comprise a microprocessor, controller, PLA, or the like) and memory 102. Though the processor 101 and memory 102 are depicted as separate elements, they may be part of a single machine, which includes a microprocessor (or other type of controller) and a memory.

The processor 101 and memory 102 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The computing unit 22 is configured to process internal information 24 generated by machine-internal sensor systems 35, external information 25 and information 26 savable in the computing unit. The operating and display unit 23 may be formed by the operating and display unit 20 in the cab of the agricultural work machine 2 or designed as an additional operating and display unit, such as part of a mobile data processing device 27 (e.g., a smartphone or tablet).

The disk mower(s) 3, 4 of the agriculture machine assembly 1 not shown in FIG. 2 may be assigned at least one control apparatus 28 that serves to control and regulate one or more work aggregates 29 of the disk mower 3. The control apparatus 28 may also be designed as a job computer and may include at least one processor (such as processor 101) and at least one memory (such as memory 102). Alternatively, the control apparatus 28 of the at least one disk mower 3, 4 may be designed as a separate terminal or a hydraulic valve assembly of the agricultural work machine 2 that forms a part of the agricultural work machine setting device 30 and/or the disk mower setting device 31.

A work aggregate 29 of the front disk mower 3 may be for example, the additional equipment 7 designed as a tine conditioner or roller conditioner. The transverse conveyor 9 of the rear disk mower 4 or the rear disk mowers 4 form an additional work aggregate 29 that is/are controlled and regulated by the control apparatus 28. setting parameters of the additional equipment 7 as work aggregates 29 of the disk mower 3, 4 are the distance from the rotating tines to the friction plates or tine combs of the tine conditioner, as well as the roller distance and/or initial tension applied to the roller conditioner. Further setting parameters of the additional equipment 7 may comprise the rotational speed of the rotating tines or rollers.

The control apparatuses 19 and 28 of the agricultural work machine 2 and the disk mowers 3, 4 may, as described, be designed separately or as a joint control apparatus that is arranged on the agricultural work machine 2 or one of the disk mowers 3, 4. Again, the various control apparatuses disclosed may comprise computing functionality described herein.

In one or some embodiments, the driver assistance system 21 is structured so that it forms an agricultural work machine setting device 30 and a disk mower setting device 31, wherein the particular setting devices 30, 31 bring about a control (such as an optimization) of the mode of operation of the agricultural work machine 2 and the at least one disk mower 3, 4 depending on each other. The driver assistance system 21 comprises set of rules 32, 33 that is for controlling (e.g., optimizing) the mode of operation of the agricultural work machine 2 and the at least one disk mower 3, 4 and is assigned to the agricultural work machine setting device 30 and the disk mower setting device 31. In one or some embodiments, the agricultural work machine setting device 30 and the disk mower setting device 31 form a common setting device 31a.

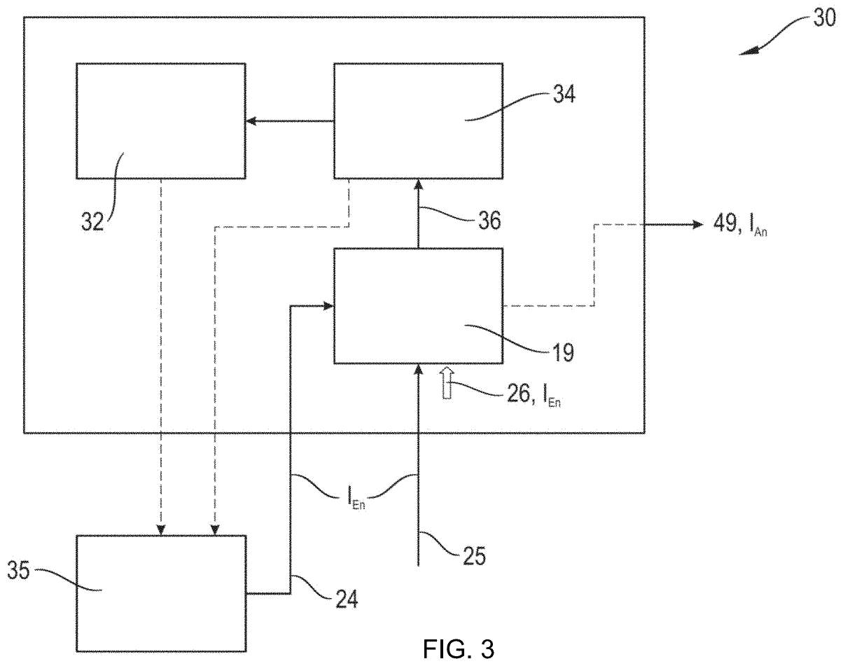

FIG. 3 shows a schematic view of the structure of one of the setting device 30, 31. The agricultural work machine setting device 30 shown as an example comprises the work aggregates 34 of the agricultural work machine 2, machine-internal sensor systems 35, and the control apparatus 19. Using a bus system, control signals 36 are sent by the control apparatus 19 to the work aggregates 34 such as the hitches 10, 11, the drive motor 16, the transmission 17 and the PTO shafts 18, with the control signals 36 serving to adjust at least one of the work aggregates 34. At least one sensor system 35 monitors at least one of the work aggregates 34 and potentially one or more actuators assigned to the work aggregates 34. The sensor data (which may comprise internal information 24) generated by the at least one sensor system 35 are transmitted via the bus system to the control apparatus 19 for evaluation. Moreover, external information 25 and information 26 that may be saved in the computing unit 22 are transmitted to the control apparatus 19.

The sensor data (which may comprise internal information 24) provided or generated by the at least one sensor system 35, the information 26 that may be saved in the computing unit 22, and the external information 25 may form input signals I_{En} of the agricultural work machine setting device 30. Output signals, or respectively adjusting parameters 49 of the agricultural work machine setting device 30, are identified by I_{An}. In one or some embodiments, the agricultural work machine setting device 30 autonomously controls (e.g., optimizes) the mode of operation of the agricultural work machine 2 (e.g., the agricultural work machine setting device 30 is configured to continuously autonomously determine and specify the required settings of the setting parameters 49 of the work aggregates 34). In one or some embodiments, the setting parameters 49 that are optimally adapted to the existing operating and mowing conditions are provided by the agricultural work machine setting device 30. The disk mower setting device 31 may be built structurally identical and operate in the same way. The particular setting devices 30, 31, or those combined into the common setting device 31a, may interdependently bring about a control (e.g., an optimization) of the mode of operation of the agricultural work machine 2 and the at least one disk mower 3, 4.

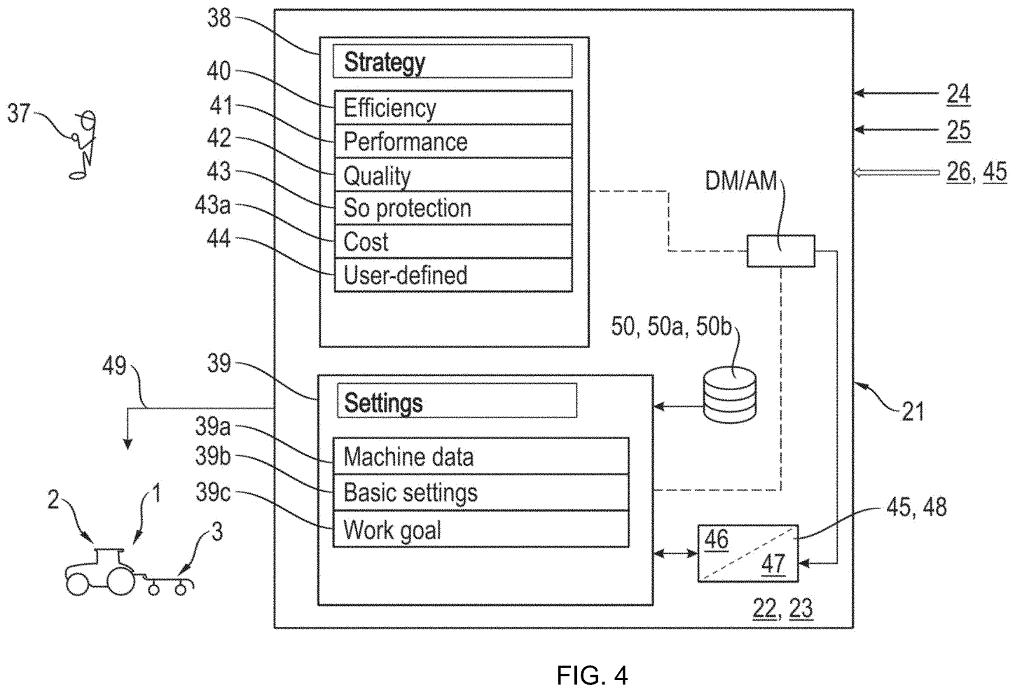

To control (e.g., optimize) the mode of operation of the agriculture machine assembly 1, the driver assistance system 21 may include selectable strategies 40, 41, 42, 43, 43a, 44 as illustrated the drawing according to FIG. 4. Even before the actual optimization begins, this allows the specification of the prioritized target setting with which an operator 37 wants to operate the agriculture machine assembly 1. The selectable strategies 40, 41, 42, 43, 43a, 44 may be work machine-specific strategies, disk mower-specific strategies, and/or a combination of both.

FIG. 4 shows a schematic representation of the driver assistance system 21 while simultaneously illustrating visualization, operating and structural aspects thereof. The driver assistance system 21 has a “Strategy” 38 module and an “Settings” 39 module that comprises a plurality of selectable individual modules: “Machine data” 39a, “Basic settings” 39b and “Work goal” 39c.

In the computing unit 22, operating parameters 45 of the agriculture machine assembly 1 may be saved as information 26 that are based on one or more manufacturer-specific basic data sets 46 of the agricultural work machine 2 and the at least one disk mower 3, 4. The particular basic data sets 46 may include all of the data that do not necessarily have to be specifically edited by an operator 37 and may be saved as generally valid and therefore predefined for the job selected by the operator 37 in the “Strategy” 38 module.

In addition, there may be user-specific basic data sets 47 that are assigned by the operator 37 to a specific agriculture machine assembly 1 or a specific agricultural work machine 2, and/or at least one specific disk mower 3, 4. In one or some embodiments, the device-specific operating parameters 45 and/or device-specific machine parameters 48 may be retrievably saved in the computing unit 22 as setting parameters 49 for different work machines 2 and/or different disk mowers 3, 4 of at least one manufacturer. In this manner, a preferably non-editable basic configuration may be provided that may be used for optimizing the mode of operation of the particular agriculture machine assembly 1 by the setting device 30, 31 or the common setting devices 31a.

By using the device-specific operating parameters 45 and/or device-specific machine parameters 48, the mode of operation of the specific agriculture machine assembly 1, in addition to the internal information 24 generated by the machine-internal sensor systems 35 and external information 25 is only optimized based on the operating parameters 45 and machine parameters 48 considered for the specific agricultural work machine 2 and the at least one specific disk mower 3, 4. Accordingly, only the setting parameters 49 may be relevant to the version of equipment of the agriculture machine assembly 1 are proposed for optimizing the mode of operation of the driver assistance system 21.

In one or some embodiments, the selectable strategies may at least comprise one, some or each of the strategies of “Efficiency” 40, “Performance” 41, “Quality” 42, “Soil protection” 43, “Cost” 43a or “User-defined” 44.

In one or some embodiments, the strategy of “Efficiency” 40 as an optimization goal is based on the reduction of fuel consumption per unit area (l/ha), and/or the reduction of the operating hours of the agriculture machine assembly 1 for processing a work order, the minimization of wear, and/or the minimization of the required time for performing headland maneuvers. In one or some embodiments, the strategy of “Efficiency” 40 may also include the duration of drying the mowed harvested material that may be influenced by the use of roller conditioners or tine conditioners as additional equipment 7 of the particular disk mower 3, 4.

In one or some embodiments, the strategy of “Performance” 41 may be oriented around the maximum achievable output per area (ha/h), and/or the increase in the operating hours of the agriculture machine assembly 1.

With the strategy of “Quality” 42, the focus may be on the work quality achievable by the at least one disk mower 3, 4 from optimized setting parameters. This may include, for example, a minimization of the proportion of crude ash and the maintenance of a minimum mowing height to ensure the subsequent growth of forage plants, in particular to minimize the spread of weeds that displace the subsequently growing forage plants. In association with this, the use of herbicides may be reduced. Another aspect that may be taken into account for the strategy of “Quality” 42 is the quality of the preparation of leaf-rich types of forage, the even spreading width of the mown harvested material over the work width of the disk mower 3, 4 and/or the type and evenness of the deposited swath.

With the optimization strategy of “Soil protection” 43, the goal of minimizing soil pressure and/or soil compaction caused by the agriculture machine assembly 1 may be achieved, and/or the traction behavior may be optimized.

With the strategy of “Cost” 43a, the cost per area (€/hectare) may be optimized taking into account the fuel, wage and/or machine costs.

The strategy of “User-defined” 44 makes it possible for the operator 37 to at least partially link the available strategies 41, 42, 43 and 43a with each other with variable proportions.

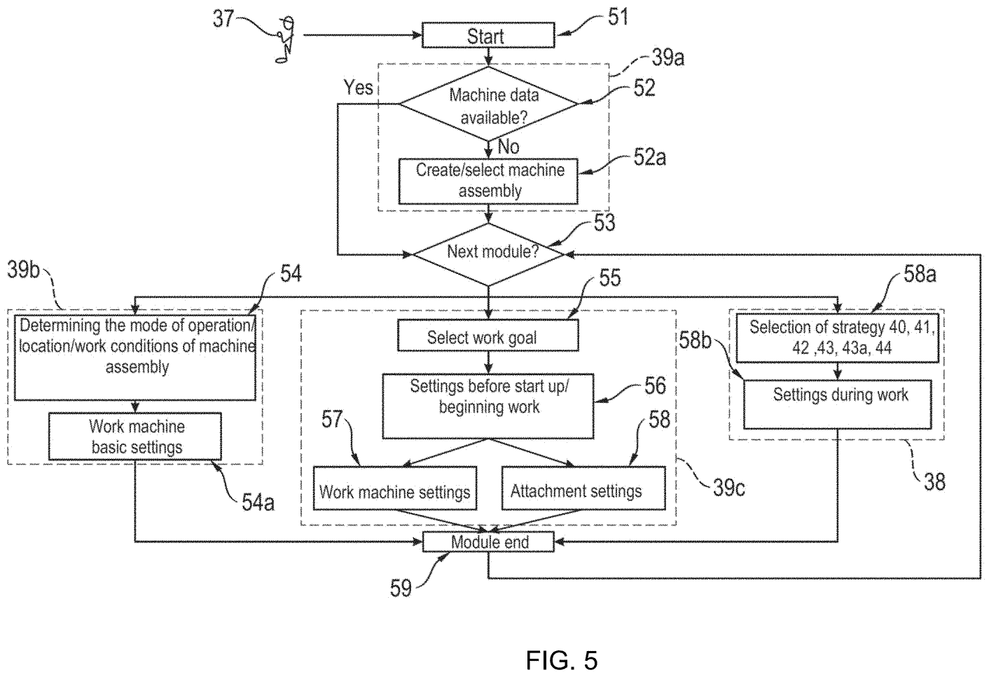

The module of “Settings” 39 with its individual modules 39a, 39b, 39c concerns inter alia the natural-language, dialog-based selection of the compilation of the agriculture machine assembly 1 by the operator 37. Data on various agricultural work machines 2 and the disk mowers 3, 4 as well as associated device-specific operating parameters 45 and/or device-specific machine parameters 48 may be retrievably saved in one or more databases 50, 50a, 50b, that may be saved in the computing unit 22. During the execution of the “Settings” 39 module, or the particular individual modules of “Machine data” 39a, “Basic settings” 39b, “Job goal” 39c as well as the “Strategy” 38 module may be accessed on these databases 50, 50a, 50b in order to identify the agricultural work machine 2 as well as the at least one adapted disk mower 3, 4. The other selection and/or setting options may be derived by using the identification while executing the “Settings” 39 module. The natural-language, dialog-based processing of the “Settings” 39 module or the selectable individual modules 39a, 39b, 39c are explained in greater detail below with reference to FIG. 5. The databases 50, 50a, 50b may be configured as external databases that may be part of the remote farm management system or the like. The “Setting” 39 module may be processed in steps.

By the “Settings” 39 module, the operator 37 is provided with an overview of setting steps 95 of the agriculture machine assembly 1 from the group of any one, any combination, or all of “Device details”, “Work conditions”, “Tire setting”, “Ballast recommendation”, “Tire pressure recommendation”, “Type of harvested material”, “Preparation on the farm”, “Preparation on the field”, “Work strategy settings”, “Device details”, “Job”, “Type”, “Coupling point and coupling type”, “Determination of weight”, and “Equipping the attachment”.

The driver assistance system 21 may also be configured such that it may either be operated in a dialog mode DM with the operator 37 or in an automatic mode AM. In both cases, communication (e.g., the dialog with the operator 37) may occur in natural language.

FIG. 5 shows a flowchart for illustrating the mode of operation of the driver assistance system 21. In a first method step 51, the driver assistance system 21 is activated by the operator 37, and module selection is activated and processed. In so doing, the operator 37 may select the individual “Machine data” module 39a or one of the other modules 39b, 39c or 38.

In method step 52, it is checked whether machine data, such as device-specific operating parameters 45 and or device-specific machine parameters 48, are present.

Depending on the result of the method step 52, an agriculture machine assembly 1 is created and/or selected in the following method step 52a in the context of processing the “Machine data” 39. The operator 37 may do this in a natural-language dialog with the driver assistance system 21, wherein the manufacturer-specific selection of the agricultural work machine 2 and at least one disk mower 3, 4 of the agriculture machine assembly 1 is made by the operator 37.

In the simplest case, the driver assistance system 21 asks the operator 37 the combination of the agriculture machine assembly 1, explained by way of example in FIG. 1, for which the creation or selection is to be initiated. For this purpose, the operator 37 may access the database 50, or respectively the manufacturer-specific and/or user-specific basic data sets 46, 47. At this point, a new agriculture machine assembly 1 may be defined and created as a new user-specific data set 47 by the operator 37. Saving may occur in the database 50.

After the agriculture machine assembly 1 is created or selected, there may be a transition to another module 38, 39b or 39c in method step 53.

The individual “Basic settings” 39b module concerns settings of the agricultural work machine 2.

The current operating state, and/or the location, and/or the working conditions of the agriculture machine assembly 1 are determined in method step 54. In the simplest case, the location may be determined by a query dialog within which the operator 37 selects the location and the current operating state. The location may be automatically determined by assigning a GPS transmitter to the agriculture machine assembly 1, such as the agricultural work machine 2, by means of which the position of the agriculture machine assembly 1 may be determined. Alternatively, the current operating state of the agriculture machine assembly 1 may be automatically determined by the driver assistance system 21 by using an operating parameter detected by a sensor system 35 of a work aggregate 34 such as the drive motor 16 or the PTO shafts 18. Operating parameters may be a certain driving speed or a certain rotational speed of the PTO shafts 18.

In the following method step 54a, the required basic settings of the agricultural work machine 2 are performed. Accordingly, before the beginning of an agricultural work process (e.g., a mowing process), setting parameters 49 to be determined and set for the agricultural work machine 2 are determined by the setting devices 30, 31 or the common setting device 31a of the driver assistance system 21 from the group of ballast, tire pressure, tire geometry, axle load, relief force of a relieving device, hitch parameters, and specified to the operator 37 as setting parameters 49 to be set and/or selected. For example, the tire geometry is determined proceeding from the manufacturer-specific basic data sets 46 of the agricultural work machine 2 saved in the tire database 50a. The driver assistance system 21 moreover makes it possible for the operator 37 to edit this information of the basic data set 46 in a natural-language dialog and save it as a user-specific data set 47. The required ballast of the agricultural work machine 2 results from the selection of the present agriculture machine assembly 1 determined in the method step 52 or 52a depending on the type, number and arrangement of the at least one disk mower 3, 4. After processing the method steps 54 and 54a of the “Basic settings” individual module, there is a return to method step 53 for another or new module selection.

The “Work goal” 39c individual module concerns specific instructions that have an additional influence on the settings of the agricultural work machine 2 and the at least one disk mower 3, 4. This may include the setting steps 95 “Type of harvested material”, “Preparation on the farm”, “Preparation on the field”, “Work strategy settings”, as well as “Device details”, “Job”, “Type”, “Coupling point and coupling type”, “Determination of weight”, and “Equipping the attachment”.

In the method step 55 to be executed according to the “Work goal” 39c individual module, the type of crop that will be mowed with the agriculture machine assembly 1 is requested as the work goal. This may include grass that is cultivated on a meadow or a field (alfalfa), clover, whole plant silage, sugarcane and other crop types. The crops may be selected by using a selection menu. Moreover, the prevailing harvest conditions may be queried in method step 55. The prevailing harvesting condition may in particular be information about any one, any combination, or all of the growth density, the growth height, or whether the harvested material is standing or lying, which may have a significant influence on the mowing process.

Depending on the result of the method step 55, setting parameters 49 are proposed by the setting devices 30, 31 or the common setting device 31a in the following method steps 56 to 58, and they are adopted by being set or selected by the operator 37 and remain unchanged for the agriculture machine assembly 1 for the duration of use while the agricultural work process is being performed (e.g., the mowing process). The settings to be made according to method steps 56 to 58 may be generally made before starting or initiating the work in the farmyard of the agriculture machine assembly 1 since manual interventions by the operator 37 are sometimes necessary that are based on the setting parameters 49 proposed by the setting devices 30, 31. In one or some embodiments, the settings to be made according to the method steps 56 to 58 may also be performed immediately before starting up on a field to be worked.

For the additional settings according to method steps 57 and 58 to the created or selected agriculture machine assembly 1, specific information on the at least one disk mower 3, 4 may be queried in method step 58, provided that this information has not already been retrievably saved as a setting parameter 49 as manufacturer-specific and/or user-specific basic data sets 46, 47 after running the “Machine data” 39a module at an earlier point in time. The specific information includes, inter alia, the manufacturer of the disk mower 3, 4, the type of disk mower, i.e., the embodiment as a front disk mower 3 or rear disk mower 4, the width of the mowing bar 6 and the number of cutting units 5 of the particular cutter (for disk mower 3, 4), and the lateral or middle mounting on the agricultural work machine 2 of a rear disk mower 4. Moreover, the type and presence of additional equipment 7, the type of control of the at least one disk mower 3, 4, the type of the hydraulic system for operating the at least one disk mower 3, 4, the type and presence of a transverse conveyor 9 for swath deposition may be requested in the natural language dialog with the driver assistance system 21. Another aspect of the method steps 57, 58 is the querying of the type of control apparatus 28 for controlling the particular disk mower 3, 4. Moreover, the type of available hydraulic system on the agricultural work machine 2 may be queried, wherein it may be, for example, an open load sensing system or a closed load sensing system. Another aspect of the method step 58 is the query of whether a transverse conveyor 9 for swath deposition is present, and how it is designed. The transverse conveyor 9, designed as a conveyor belt or screw conveyor, of a disk mower 3, 4, in this case rear disk mower(s), may be proposed for selection by the operator 37.

The information determined in method steps 52 to 54 may be used for the further processing of modules 38 and 39c.

In method step 58, the settings are made to the at least one disk mower 3, 4. These comprise setting parameters 49 to be determined by the driver assistance system 21 for the at least one disk mower 3, 4 of any one, any combination, or all from the group of Type of at least one disk mower 3, 4, Position and means for arranging the at least one disk mower 3, 4 on the agricultural work machine 2, Presence and type of additional equipment 7 on the at least one disk mower 3, 4 before starting up the agriculture machine assembly 1 and/or initiating an agricultural work process by the agriculture machine assembly 1. By using the type of particular disk mower 3, 4, the position of the assembly on the agricultural work machine 2 may sometimes be inferred.

Moreover, before starting up the agriculture machine assembly 1 and/or the beginning of an agricultural work process by the agriculture machine assembly 1 in method step 57, at least one setting parameter 49 from the group of: drive rotational speed of at least one PTO shaft 18 of the agricultural work machine 2, hitch setting parameter, type of attachment device for indirectly or directly adapting to the at least one disk mower 3, 4 to the agricultural work machine 2, parameter of the attachment device, cutting height, relief force of a relief device, distance from the soil of a soil contour adaptation device, coupling distance to the agricultural work machine 2, may be determined and specified as a setting parameter 49 to be set and/or selected by the operator 37.

Accordingly, hitch setting parameters and/or the type of attachment device for the indirect or direct adaptation of the disk mower 3, 4 to the agricultural work machine 2 and operating parameters of the attachment device may be determined in the farmyard as setting parameters 49 by the driver assistance system 21. The disk mower 3, 4 may be attached indirectly by a quick coupling frame that is described for example in EP 3 351 074 A1, or directly to an upper link 11a and lower link 11b, for example the rear hitch 11, or correspondingly to the upper link and lower links of the front hitch 10. The hitch setting parameters are the vertical and lateral adjustability of the links and their locking, as well as the adjustable length of lifting struts of the particular hitch 10, 11.

In one or some embodiments, the front hitch 10 is designed with a relief device for reducing the amount of weight that is supported by the disk mower 3 in work position on the ground which, depending on the design of the agricultural work machine 2, may be designed as a tension spring, or as a hydraulic cylinder with a chain, or as an integrated relief device that is described by way of example in EP 2 316 256 A1.

To adjust the relief force, the spring force may be set by the length of the chain that is specified by the disk mower setting device 31 of the driver assistance system 21. When the hydraulic cylinder is the relief device or the integrated relief device, a hydraulic pressure to be set may be specified.

The presence of roller conditioners as additional equipment 7 may necessitate an adaptation of the hydraulic pressure with which they are operated. Depending on the cutting height to be set, it may be necessary to use high-cut skids of varying height.

Before the beginning of the mowing process, the drive rotational speed of the PTO shafts 18 to be set is specified by the driver assistance system 21. The particular drive rotational speed to be set depends on the type and the work width of the disk mower 3, 4.

The driver assistance system 21 may be such that the ascertained setting parameters 49 are either set directly (e.g., by indirectly or directly controlling actuators or the like) provided that a manual intervention by the operator 37 with the agricultural work machine 2 and/or the disk mower 3, 4 is unnecessary. In this case, the operator 37 may be asked whether the ascertained setting parameters 49 should be set. Alternatively, the setting parameters 49 are displayed, and the operator 37 then may initiate their setting, or cause them to be set by a manual intervention.

A manual setting is, for example, mounting a disk mower 3, 4, the arrangement of prop shafts that are adjustable in length, and/or the setting of the length of the prop shafts, the setting of swathing plates, and the like.

After the individual “Work goal” 39c module has been processed, there is a switch to method step 59 “Module end”, and a jump back to method step 53. In method step 53, the operator 37 has the option of executing another of the individual modules 39a, 39b, 39c or module 38, including once again.

The at least single execution and processing of the individual “Machine data” 39a module of the “Setting” 39 module for a specific agriculture machine assembly 1 may be needed for the necessary information to be available to the driver assistance system 21 that forms the agricultural work machine setting device 30 and the disk mower setting device 31 for executing the modules “Selection strategy” 38, “Basic setting” 39b, and work goal” 39c. Since a selection of the “Strategy” 38 module and the individual modules “Basic settings” 39b and “Work goal” 39c may be carried out independent of the individual module “Machine data” 39a, plausibility queries are provided within the modules 38, 39b, 39c to check whether the agriculture machine assembly 1 was selected by executing the individual “Machine data” 39a module.

The menu guidance and operating concept of the driver assistance system 21 may all be based on explaining setting recommendations in addition to natural language dialog by using icons, pictograms, illustrations with magnified views and/or colored highlights.

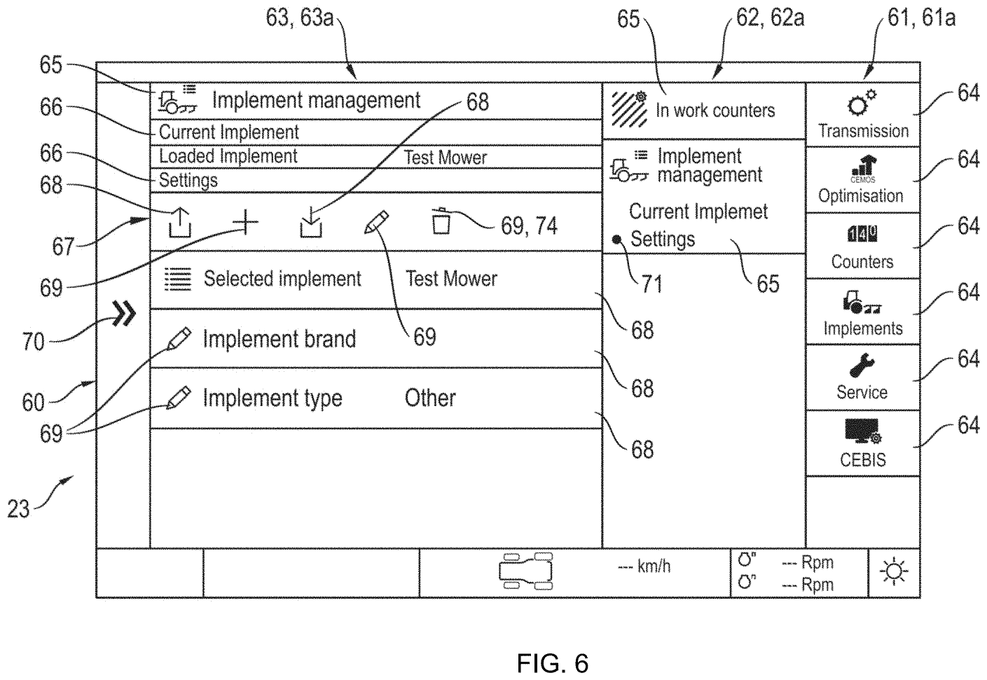

In FIGS. 6 to 18, the menu guidance and operating concept of the driver assistance system 21 is explained by way of example with individual setting parameters 49 of the agriculture machine assembly 1. Reference is made to the above statements regarding FIGS. 1 to 5. The menu guidance and operating concept of the driver assistance system 21 may all be based on explaining setting recommendations in addition to natural language dialog with the operator 37 by using icons, pictograms, illustrations with magnified views and/or colored highlights.

FIG. 6 schematically portrays a first view of the at least one operating and display unit 23 with the example of selecting a disk mower 3, 4. The at least one operating and display unit 23 is configured to show at least three adjacently arranged visualization areas 61, 62, 63 in a first operating and display level 60. The visualization areas 61, 62, 63 are positioned next to each other in a hierarchically descending order. Hierarchically descending positioning means starting from a main menu level 61a in the hierarchically ascending visualization area 61 that selectively depicts superordinate main menu items 64 to a menu level 62a underneath in the visualization area 62 that depicts the menu items 65 belonging to the particular superordinate main menu item 64 that is hierarchically next to the lowest visualization area 63 with a submenu level 63a. In the visualization area 63, a ribbon 67 is shown with specifying selection options 68, setting options 69 and/or operating options 70 that are assigned to the menu item 65 previously selected in the visualization area 62. The structure and scope of the ribbon 67 as well as the scope in which the selection options 68, setting options 69 and operating options 70 are available may vary depending on the selected menu item 65. The selection options 68 contained in the ribbon 67, setting options 69 and operating options 70 may be selected by touching the touch-sensitive surface of the operating and display unit 23.

For example, according to the depiction in FIG. 6 in the top menu level in the visualization area 61, a selection of the main menu item 64 “Implements” (“Attachments”) has been made by the operator 37. In the adjacently arranged visualization area 62, the menu level 62a underneath belonging to the main menu item 64 is shown in which the menu item 65 “implement management” (“Attachment management”) has been activated by the operator 37. Next to the particular selectable menu item 65, an overview of the submenu items 66 contained on the submenu level 63a of the visualization area 63 may also be shown when a selection of a menu item 65 in the visualization area 62 has been made.

A particular selection made within the particular visualization areas 61, 62, 63 is visually highlighted. For this, the selection made by the operator 37 may for example be highlighted by an inverted depiction, an additional border and/or a different color of the selection and the like.

The selected menu item 65 as well as the associated submenu items 66 are shown in the visualization area 63. In the shown exemplary embodiment, the submenu item 66 “Settings” is actively selected. The made selection, the submenu item 66 “Settings”, is highlighted in the visualization areas 62 higher in the hierarchy by a selection indicator 71. The selection indicator 71 may be a preceding icon or a visual highlight, for example by a frame and/or the differently colored design.

The display size of the particular visualization area 61, 62, 63 may decrease in a hierarchical manner (e.g., the visualization area 61 of the top hierarchy level takes up the smallest area of the area available for visualization of the operating and display unit 23).

In one or some embodiments, the selection options 68 and setting options 69 may be shown as icons and/or pictograms in the ribbon 67. The icons or pictograms may be designed to be self-explanatory by the specific shape so that the operator 37 may be oriented by them without requiring additional context. An additional insertion of a context window for explaining the selection options 68 and setting options 69 contained in the ribbon 67 is also contemplated.

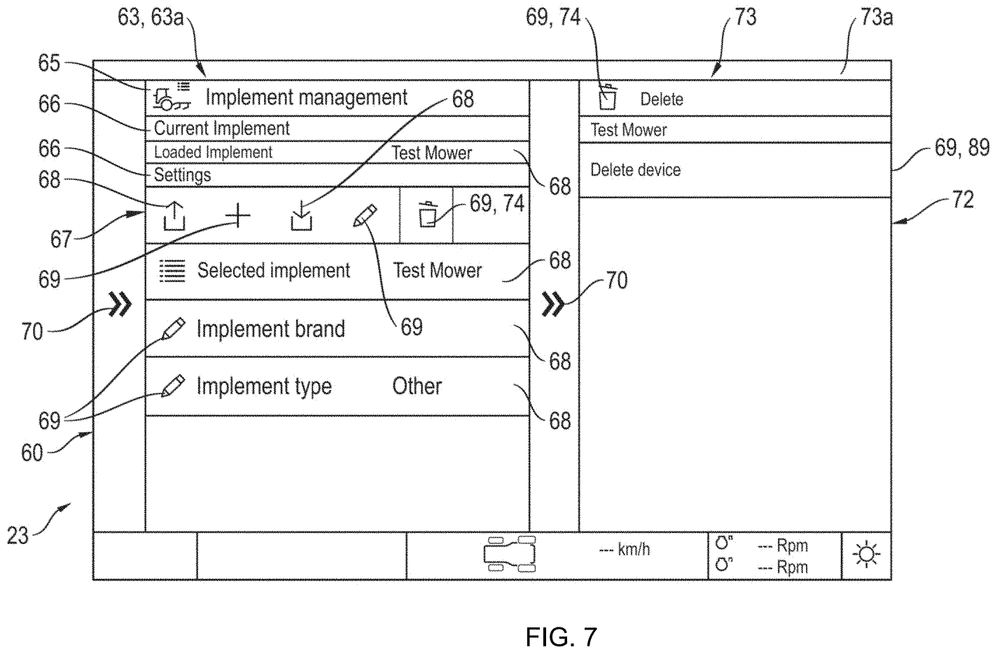

FIG. 7 shows an example of how the depiction changes by the operating and display unit 23 by selecting a specific setting option 69, in this case a deletion option 74, in the ribbon 67, by means of which the deletion of an existing, user-specific basic data set 47 for a disk mower 3, 4 may be invoked (e.g., a setting is changed). By selecting the deletion option 74 “Delete” as a setting option 69, a setting and visualization area 73 is superimposed or overlaid over the two hierarchically higher visualization areas 61 and 62 in a second operating and display level 72. The setting and visualization area 73 serves to select and/or adjust setting parameters, which may also include the deletion of an individual setting parameter up to a complete data set. The driver assistance system 21 may be configured for a dialog-based, natural-language determination of the setting parameters for selection and/or setting.

In the second setting and visualization area 73, explanations may also be shown in addition to the selection options 68 designed as pictograms. In the case of the delete option 74 shown as an example, the “Delete” context belonging in the context field 73a as well as the object affected by the selection, i.e., for example a downloaded basic data set 47 of the agricultural work machine 2, the disk mower 3, 4 and/or a work aggregate 29, 34.

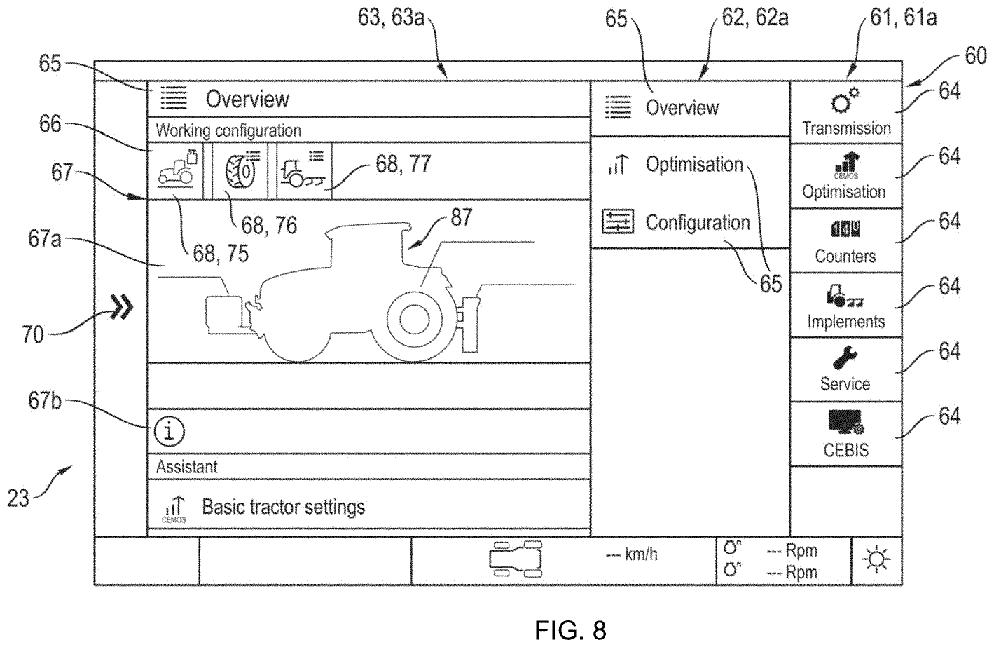

FIG. 8 shows an example of the selection of the main menu item 64 “Optimization” in the visualization area 61 to which are assigned the module “Strategy” 38 and the module “Settings” 39 and its individual modules “Machine data” 39a, “Basic settings” 39b, and work goal” 39c of the driver assistance system 21 for processing, as well as the selection of the menu item 65 “Overview” in the visualization area 62.

In the ribbon 67 displayed in the hierarchically lowest visualization area 63, icons or pictograms 75, 76, 77 are shown as the selection options 68 that relate to the setting parameters of ballast (pictogram 75), tire pressure, tire geometry and axle load (pictogram 76) as well as basic settings (pictogram 77) for the at least one disk mower 3, 4. Below the ribbon 67 abstracted in a separate display section 67a, the agricultural work machine 2 or the disk mower 3 are shown as a symbol 87 as well as a basic assignment of the pictograms 75, 76 and 77. Below the display section 67a, an information field 67b may be provided in which additional instructions are shown that are associated with a proposed recommendation for the setting parameters 49 to be currently adapted.

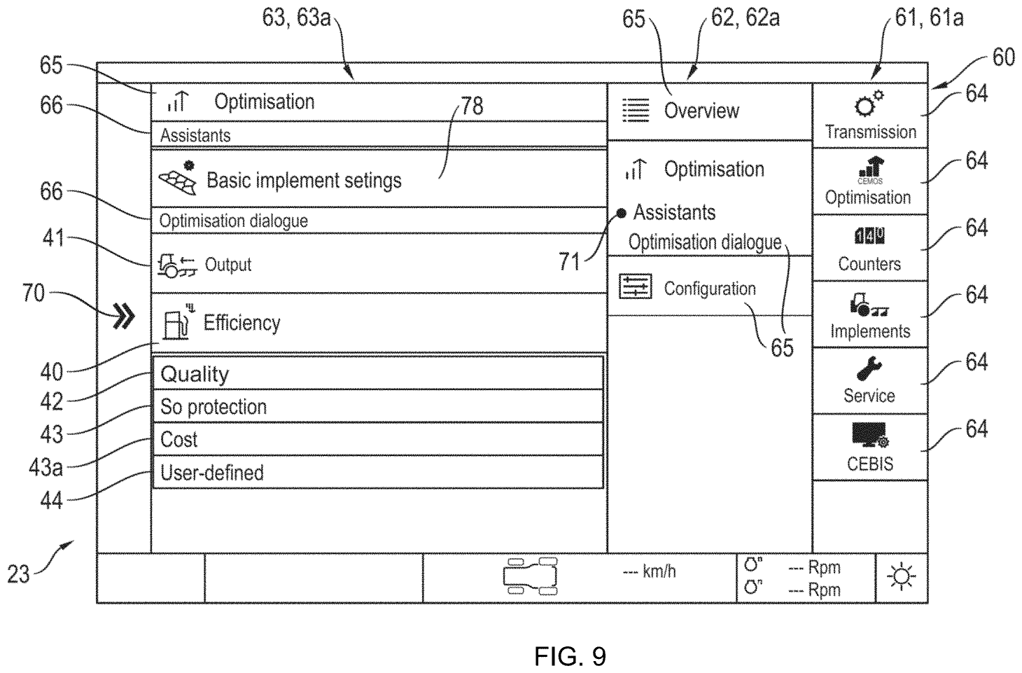

FIG. 9 shows an example of the made selection of the main menu item 64 “Optimization” in the hierarchically highest optimization area, as well as the selection of the menu item 65 of the same name, “Optimization”, in visualization area 62. In this case as well, an overview of the submenu items 66 contained in the submenu level 63a of the visualization area 63 is also shown in the visualization area 62 below the menu item 65.

The selection of one of the submenu items 66 in the visualization area 63 may cause either the “Strategy” 38 module or “Basic machine assembly setting” 39 module to be started. The “Optimization dialog” submenu item 66 includes the strategies 40 of “Efficiency” and “Performance” 41. The “Assistants” submenu item 66 includes the “Basic machine assembly setting” 39 module and its processing. For this, the selected “Assistants” 66 submenu item offers a “Basic implement setting” assistant 78 for the selection that is for the dialog-based configuration of the at least one disk mower 3, 4.

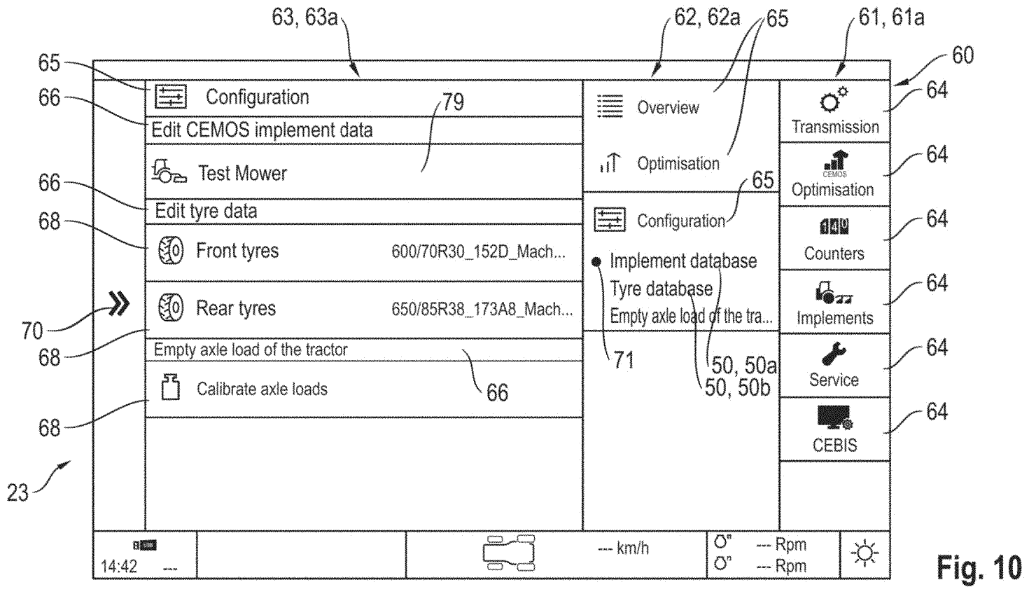

FIG. 10 shows an example of the selection of the “Configuration” 65 menu item in the visualization area 62, as well as the selection of the submenu items 66 that are selectably assigned to the “Configuration” 65 menu item. The name of a data set of the disk mower 3, 4 currently retrieved from the database 50 is shown in the visualization area 63 in the dialog field 79. The submenu items 66 show the available selectable selection options 68 of the “Configuration” 65 menu item. In the dialog field 79, the “Edit CEMOS implement data” submenu item 66 has the name of the disk mower 3, 4 selected from the database 50 that includes a specific attachment database 50a for disk mowers. The term “CEMOS” is a registered trademark of CLAAS KGaA mbH. The selection made by using the attachment database 50a is highlighted by the selection indicator 71.

The selection and/or setting of the tires on the front axle 12 and rear axle 13 of the agricultural work machine 2 are available as selection options 68 of the “Edit tire data” submenu item 66. The database 50 that includes a specific tire database 50b is available for selecting the particular tires. The “Calibrate axle loads” selection option 68 for preadjusting the axle load is available as a selection option 68 of the “Empty axle load of the tractor” submenu item 66.

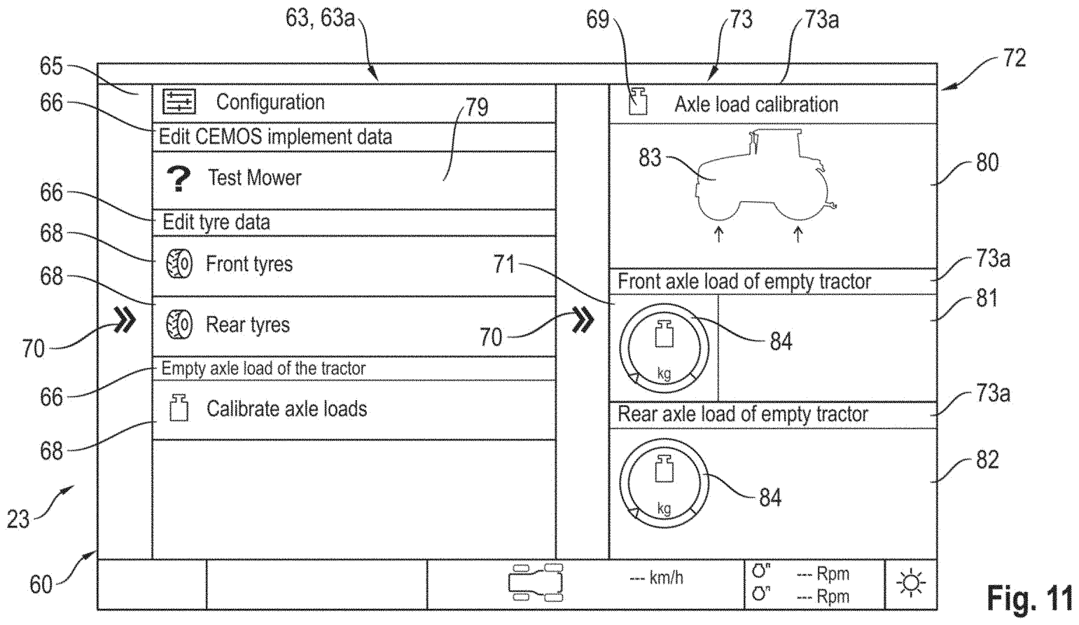

FIG. 11 shows the operating and display unit 23 after selecting one of the available selection options 68, in this case for example the selection option “Calibrate axle loads”. Selecting the selection option 68 in the hierarchically lowest visualization area 63 causes the setting and visualization area 73 to be superimposed or overlaid over the two hierarchically higher visualization areas 61 and 62 in a second operating and display level 72.

In the setting and visualization area 73 of the second operating and display level 72, the corresponding component to be set in the subarea 80, which in the present case is the agricultural work machine 2, is displayed on the basis of the selected selection option 68, here by way of example the selection option “Calibrate axle loads”, distributed over several subareas 80, 81, 82. The component to be set is shown in the subarea 81 as an icon or pictogram 83. The “Calibrate axle loads” selection option 68 may be available if no information, or only incomplete information, on the setting parameters 49 relating to the axle load is saved for an agriculture machine assembly 1 to be operated and optimized with respect to the agricultural work machine 2. The subareas 80, 81, 82 may be assigned context fields 73a that contain explanations in a graphic and/or text-based form.

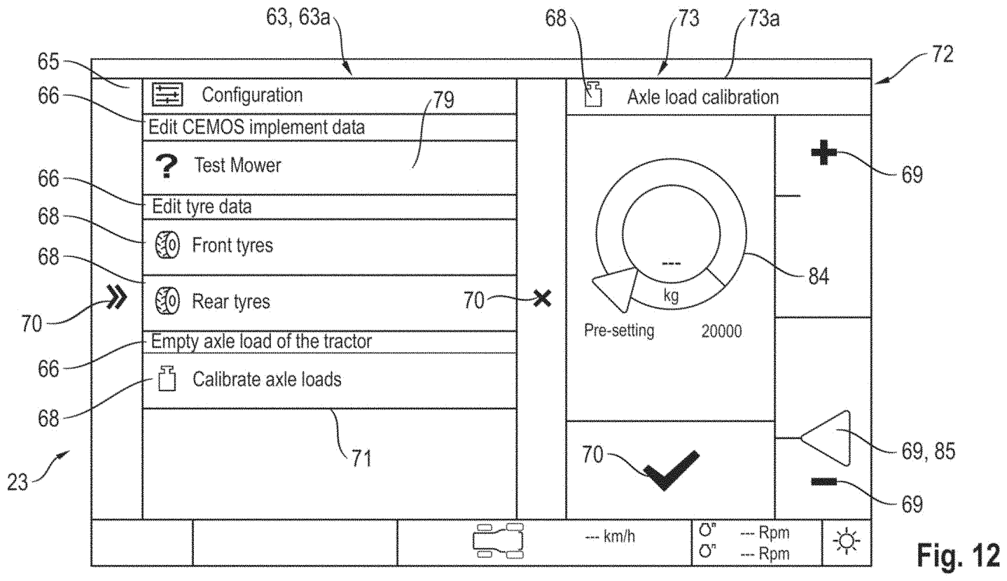

In the subareas 81 and 82, the specific parameters of the component to be set are named, in this case, the “Front axle load” in the subarea 81, and the “Rear axle load” in the subarea 82. In the subareas 81 and 82, the associated set value, in this case for the set axle load distribution, is also shown by a display field 84. The particular display field 84 is designed as a combined field. Designing the display field 84 as a combined field makes it possible to show the set value, in this case for an axle load, as an absolute value as well as in graphic form, for example in the form of a ring diagram. By selecting the “Axle load calibration” setting option 69 in the subarea 80, for example by touching the surface of the operating and display unit 23, by virtual control elements, and/or by a manual actuation of electromechanical control elements that are assigned to the operating and display unit 23, the display in the setting and visualization area 73 of the second operating and display level 72 are changed as shown for example in FIG. 12. The virtual and/or electromechanical control elements may for example be designed as switches, pushbuttons, dials, sliders, rotary pushbutton switches, and the like.

FIG. 12 shows the changed setting and individualization area 73 of the second operating and display level 72 of the operating and display unit 23 after the selection of the setting option 69 “Axle load calibration”. In the setting and visualization area 73, a context field 73a is shown that corresponds with the selected selection options 68. Below the context field 73a is located a graphic visualization of at least one setting parameter, in this case the set axle load distribution. The valve for the axle load distribution is set using the setting options 69 and the operation option 70 that are shown in the setting and individualization area 73. Whereas the setting options 69 shown by way of example as a plus symbol (“+”) and minus symbol (“−”) serve to set the value of the axle load distribution, a set value may be confirmed and saved using the operating options 70, or the process may be canceled as such. By confirming one of the operating options, the operator 37 returns to the previous display according to FIG. 11. In addition, a setting option 69 designed as a marker 85 may be provided in the setting and visualization area 73. The marker 85 may be operated by a linear sliding movement.

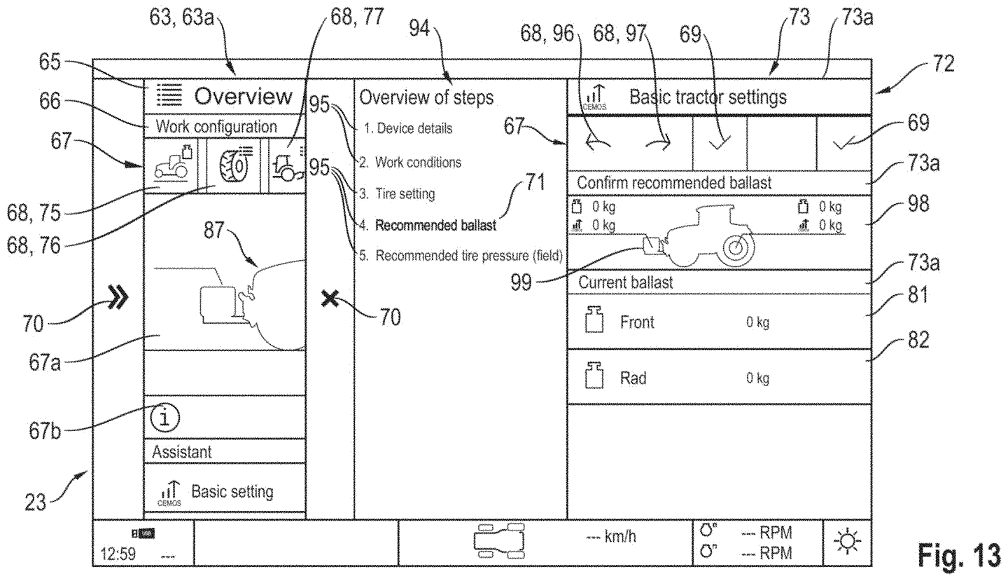

FIG. 13 shows by way of example a view of the operating and display unit 23 that may adjust when the processing of the individual “Machine data” 39b module is carried out. The setting and visualization area 73 shows an example of a part of the process that occurs when the method step 54a for the basic setting of the agricultural work machine 2 is executed. To accomplish this, the setting and visualization area 73 is divided in order to show in a separate segment 94 of the setting and visualization area 73 an overview of one or more setting steps 95 that is/are to be processed by the operator 37 when executing the method step 54a for the basic setting of the agricultural work machine 2. Using the selection options 68 shown in the dialog field 79 that are designed as directional arrows 96, 97, the operator 37 may personally navigate between the dialog queries of the particular setting step 95 and the setting steps 95. The directional arrows 96, 97 enable jumping forward and backward. An active setting step 95 is highlighted, in this case the “Ballast recommendation” setting step 95. The term “Setting step 95” is to be understood as meaning that one or more dialog queries are hidden behind it. It may be mandatory for the operator 37 to respond to all provided dialog queries of a setting step 95 during method steps 54 to 58 to reach the following setting step 95.

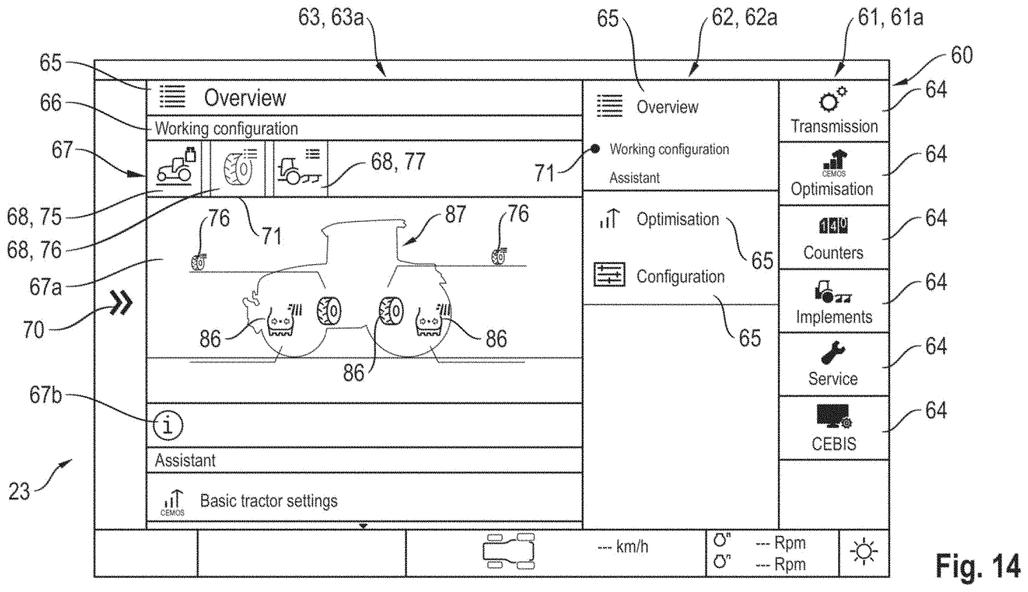

FIG. 14 shows an example of the selection of the “Optimization” main menu item 64 according to FIG. 8 in the visualization area 61, as well as the selection of the “Overview” 65 menu item in the visualization area 62. In the hierarchically lowest visualization area 63, the work configuration is selected using the displayed ribbon 67 as selection options 68 for the setting parameters of tire pressure, tire geometry and axle load of the agricultural work machine 2 visualized by the pictogram 76 highlighted in the ribbon 67. Icons or pictograms 76, 86 abstracted corresponding to the selected selection options 68 are inserted into the separate display section 67a that, in the depicted exemplary embodiment, illustrate the setting parameters of tire pressure and tire geometry associated with the selection option 68. The settings that may be made here are contained in the “Basic settings” 39b individual module.

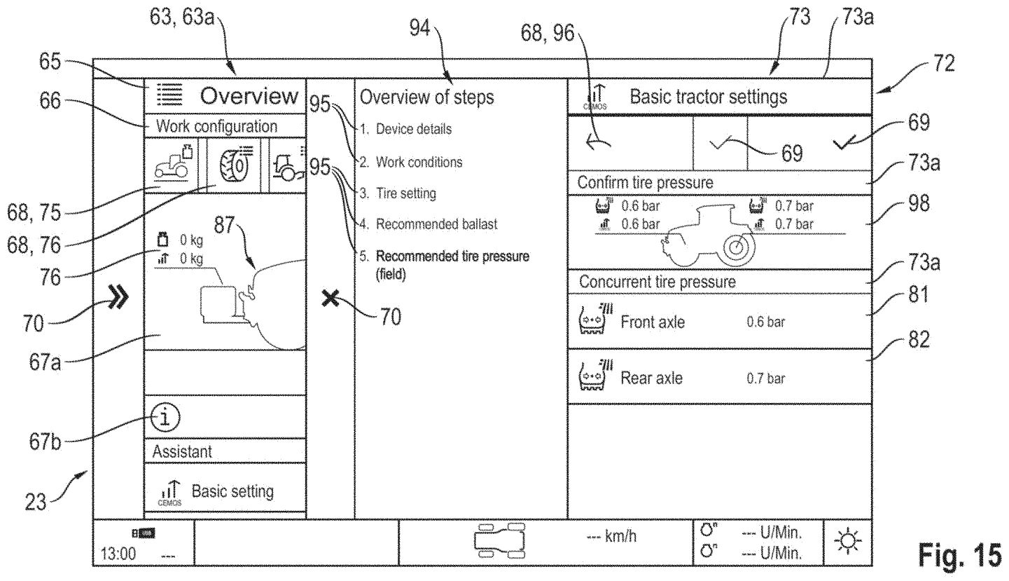

FIG. 15 shows by way of example a view of the operating and display unit 23 that may be set when the “Ballast recommendation” setting step 95 was carried out while processing the individual “Machine data” 39b module, and a switch is made to the next individual step 95, “Tire pressure recommendation (field)”.

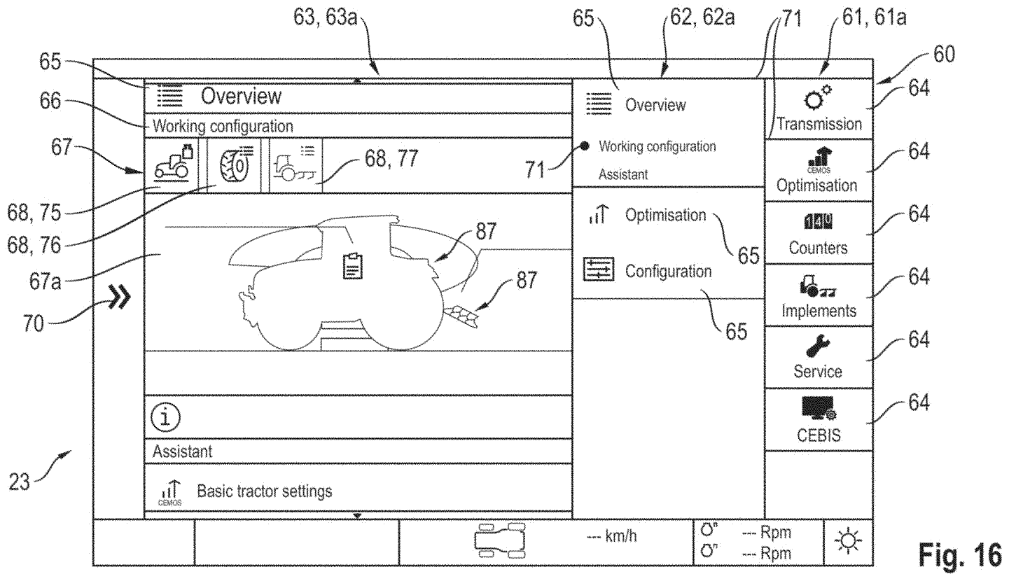

FIG. 16 shows an example of the selection of the “Optimization” main menu item 64 according to FIG. 8 in the visualization area 61, as well as the selection of the “Overview” 65 menu item in the visualization area 62. In the hierarchically lowest visualization area 63, the work configuration Made basic settings (pictogram 77) for the at least one disk mower 3, 4, visualized by the pictogram 77 highlighted in the ribbon 67, is selected by means of the displayed ribbon 67 as selection options 68.

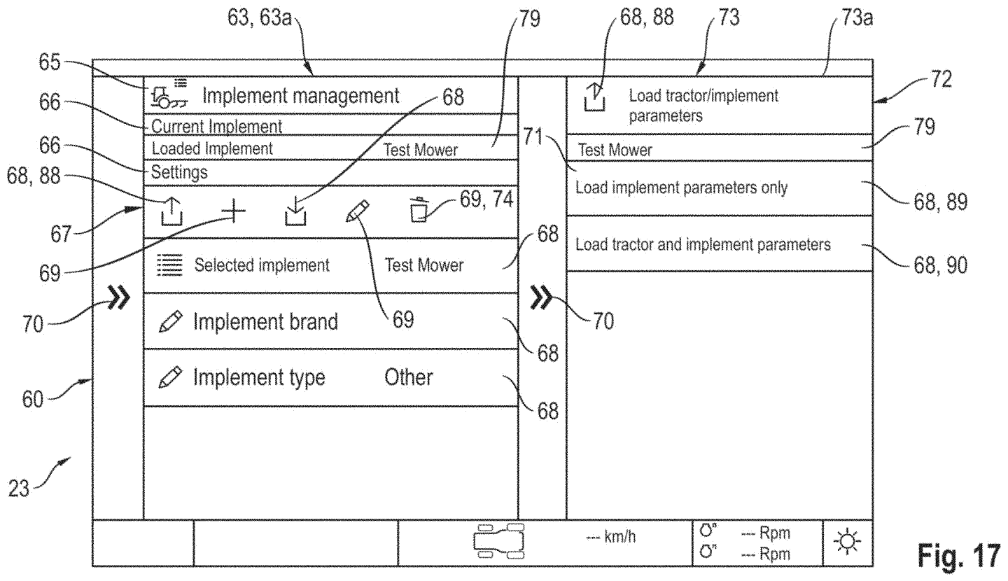

FIG. 17 shows a view of the operating and display unit 23 according to FIG. 6 that is depicted by actuating one of the selection options 68, in this case a selection option “Load tractor/implement parameters” 88, the selectable downloading of an existing data set 46, 47 for an agricultural work machine 2 and/or a disk mower 3, 4. The available setting options 89 “Load implement parameters only” or “Load tractor and implement parameters” 90 are in the setting and visualization area 73 of the second operating display level 72 below the context field 73a corresponding to the actuation of the selection options 68, 88 from the ribbon 67.

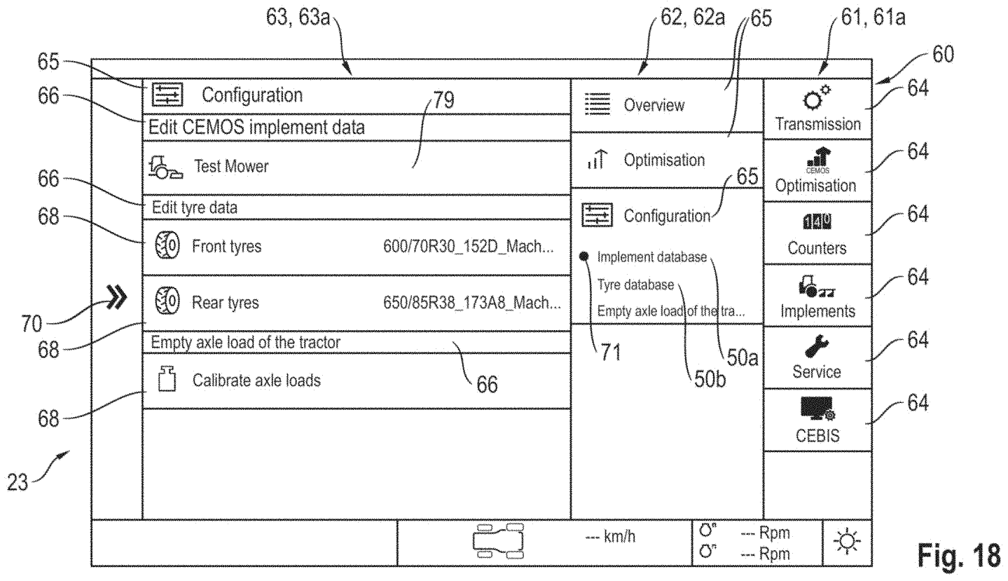

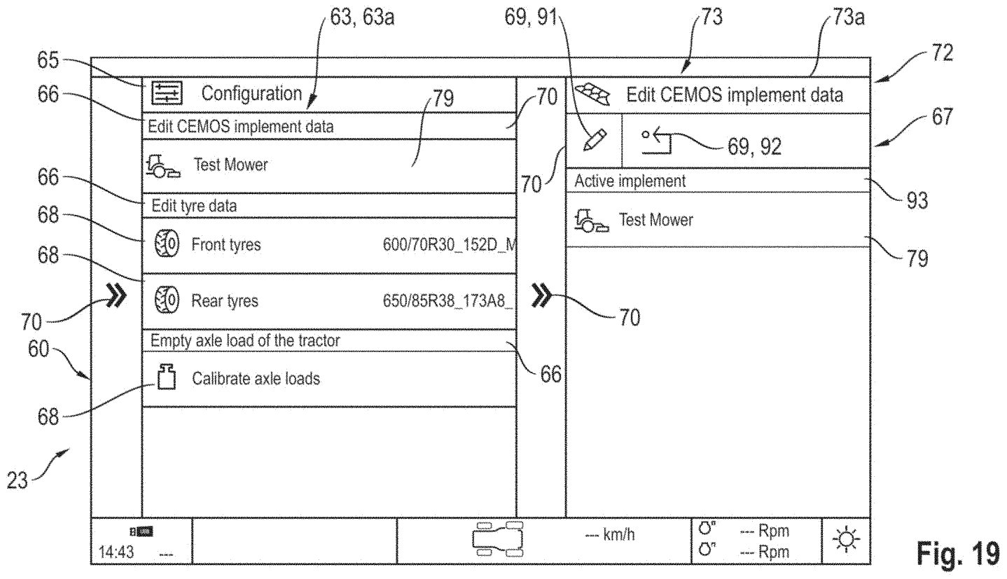

The depiction in FIG. 18 shows a view of the operating and display unit 23 according to FIG. 10 which is activated and shown by the selection of the main menu item 64 “Optimization” and the associated “Configuration” 65 menu item. The name of a data set 46, 47 of the disk mower 3, 4 currently retrieved from the database 50, in this case of the attachment database 50a, is shown in the visualization area 63 in the dialog field 79. By selecting, or respectively touching the dialog field 79, the two hierarchically higher visualization areas 61 and 62 are inserted or superimposed in the second operating and display level 72 by the setting and visualization area 73 of the second operating and display level 72, which is shown in FIG. 17. In the setting and visualization area 73, a dialog ribbon 67 is shown below the context field 73a that is designed analogous to the dialog ribbon 67 of the hierarchically lowest visualization area 63 of the first operating and display level 60. In the dialog ribbon 67 of the setting and visualization area 73, the available setting options 69 are shown, in this case an icon or pictogram 91 that constitutes the editing function, as well as the icon or pictogram 92 that, when selected, makes it possible to leave the setting and visualization area 73 of the second operating and display level 72. Below an additional field 93 “Active implement”, the name of the data set 46, 47 of the disk mower 3, 4 currently retrieved from the database 50 is shown in the dialog field 79. As shown further in FIG. 19, the setting options 69 depicted by the icon or pictogram 91 is activated in the dialog field 79.

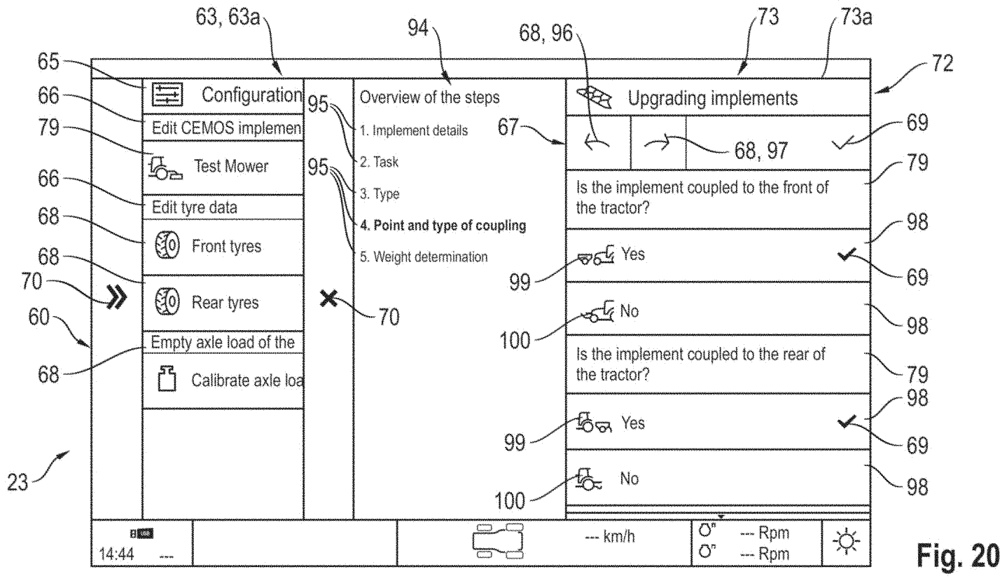

FIG. 20 shows the view of the operating and display unit 23 that results from actuating or selecting the icon or pictogram 91 in the dialog field 79 according to FIG. 19. The setting and visualization area 73 shows an example of a part of the process that occurs when the method step 53 for the basic setting of a retrofitted disk mower is executed. To accomplish this, the setting and visualization area 73 is divided in order to show, in a separate segment 94 of the setting and visualization area 73, an overview of one or more setting steps 95 that is/are to be processed by the operator 37 when executing the method step 53 for basic setting. At the same time, in the respective setting step 95, corresponding queries are shown in the dialog fields 79, and setting options 69 and/or selection option 68 are shown in the associated display segments 98. In FIG. 20, this is explained by way of example in the step “Point and type of coupling” as part of the basic setting. In the dialog field 79, the location at which the disk mower 3, 4 to be set is arranged is queried in steps. By means of the selection options 68 shown in the dialog field 79 that are designed as directional arrows 96, 97, the operator 37 may navigate between the dialog fields 79. The directional arrows 96, 97 enable jumping forward and backward. By actuating the setting option 69, an actuated entry of a setting step 95 is concluded by the operator 37 in order to save the entered information.

The display of the setting options 69 and/or selection options 68 shown in the dialog fields 79 and the associated display segments 98 vary depending on the setting step 95 to be executed. Corresponding to the possible setting options 69 and/or selection options 68, a graphic depiction 99, 100 of at least one component to be set, for example of the agricultural work machine 2 and/or the disk mower 3, 4 are inserted as a whole in the display segments 98, or individual work aggregates 29, 34 are inserted in order to additionally illustrate the context of the natural language question displayed in the dialog field 79 as well as the associated setting options 69 and/or selection options 68. The selection is carried out by touching the display segments 98, or by actuating an operating element of the operating and display unit 23.

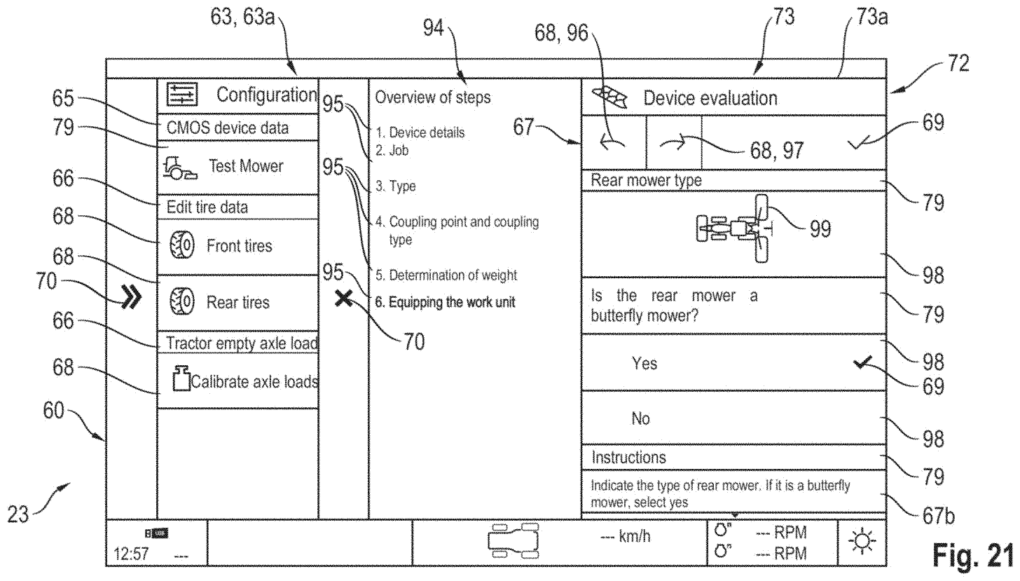

In FIGS. 21 to 30, other examples of individual setting steps 95 are shown that are processed in the method steps 57 or 58 while the individual “Work goals” 39c module is being executed.

FIG. 21 shows the setting step 95 “Equipping the work unit” to be processed as an example of the dialog query concerning the type of rear disk mower. For this purpose, a graphic depiction 99 specific to the rear disk mower type is displayed in a display segment 98 below a dialog field 79, in order to illustrate the object to the operator 37 to simplify the response to the dialog query. By touching one of the two display segments 98 that contain the answer to the dialog query, a selection is made and identified as active by the selection options 69. By responding to this dialog query, the selection option 68 is activated in the associated ribbon 67 of the setting and visualization area 73 in order to go to a subsequent setting step 95 or to be able to finish the execution of the individual “Work goals” 39c module in order to go to method step 59 “Module end” according to FIG. 5.

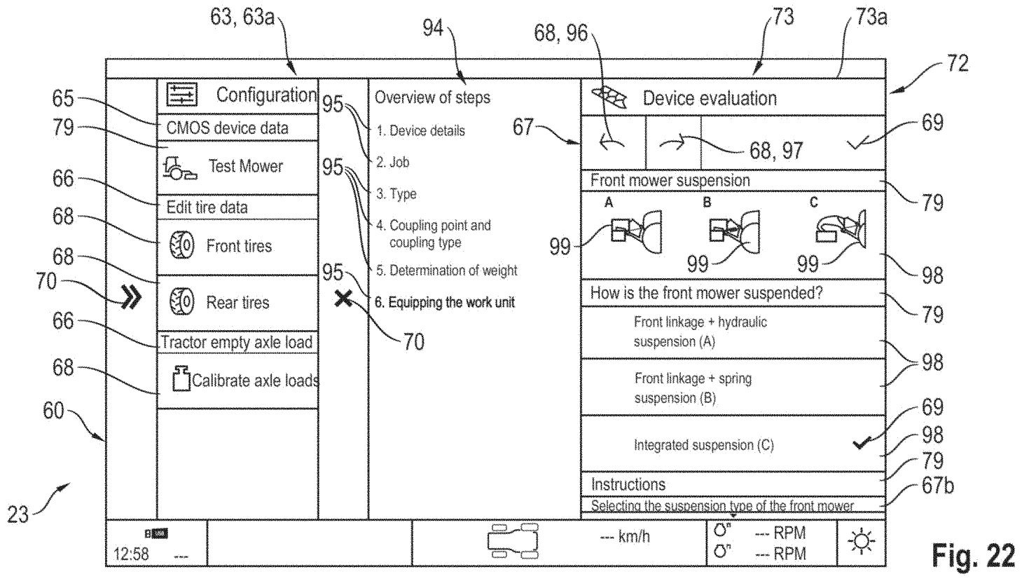

FIG. 22 shows the selected setting step 95 “Equipping the work unit” as an example of the dialog query on how the front disk mower 3 is arranged on the agricultural work machine 2. For this, several graphic depictions 99 are displayed in a display segment 98 below a dialog field 79 that graphically illustrate the potential types of the arrangement on the agricultural work machine 2. For graphic illustration, the response options corresponding with the graphic depictions 99 are shown in the other display segments 98.

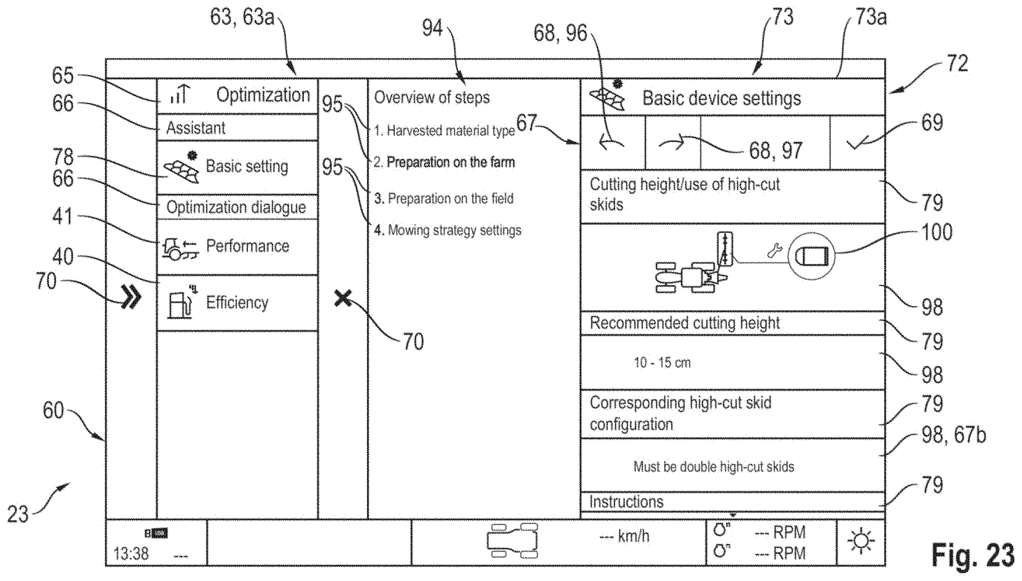

FIG. 23 shows a view of the operating and display unit 23 that appears upon selecting the submenu item 66 “Assistants” according to FIG. 9. The assistant 78 “Basic implement setting” again includes several setting steps 95 to be processed that are for the dialog-based configuration of the at least one disk mower 3, 4 during the method step 58. In this case for example, the setting step 95 “Preparation in the farm” is active. In the setting and visualization area 73, information on the dialog query is shown for example on which cutting height should be set, and whether high-cut skids need to be used. For this, a graphic depiction 99 specific to the arrangement of high-cut skids on the rear disk mower 4 is shown in a display segment 98 below a dialog field 79. In the other dialog fields 79 and display segments 98, a recommended cutting height as well as a configuration of the high-cut skids specific to the cutting height are shown.

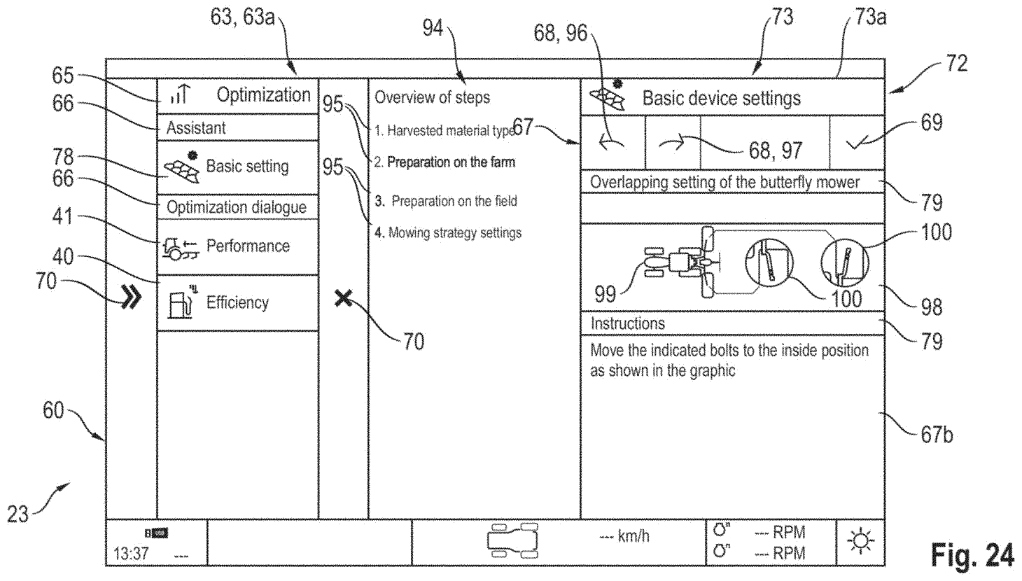

FIG. 24 shows the selected setting step 95 “Preparation on the farm” as an example for a dialog for the overlapping setting of an arrangement of two disk mowers 4 designed as a butterfly combination.

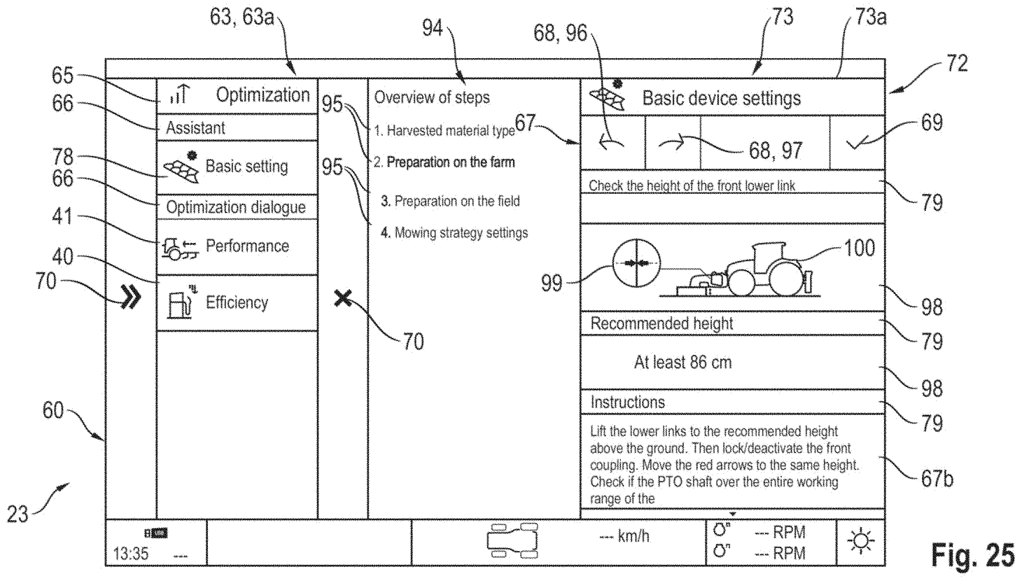

FIG. 25 also shows the selected setting step 95 “Preparation on the farm” as an example for the note dialog for controlling the height setting of the lower links of the hitch 10. In addition to a recommended height, additional text instructions or notes are provided in the information field 67b on how to make the setting. Supplementary or explanatory visual notes are depicted in a display segment 98.

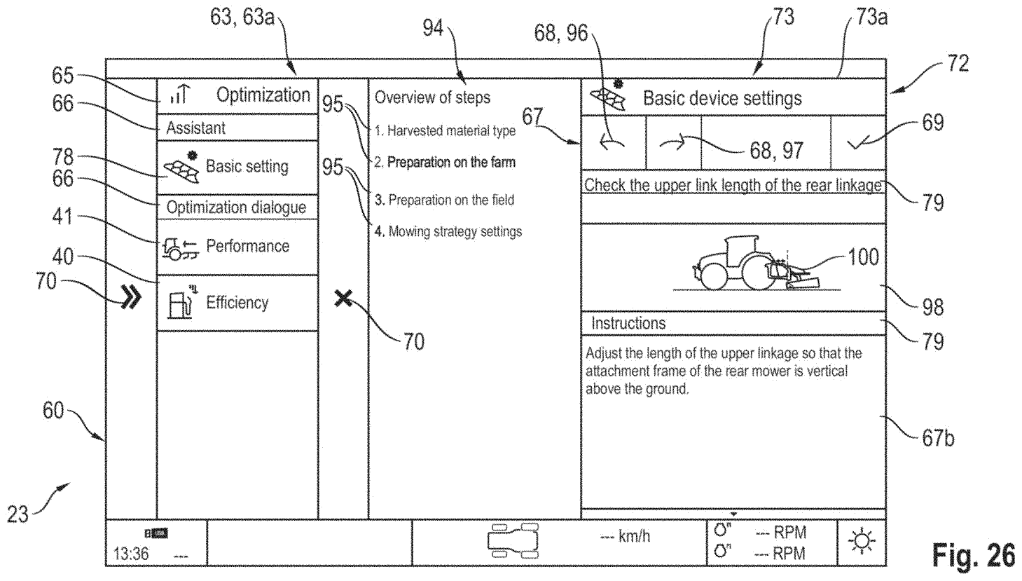

FIG. 26 also shows the selected setting step 95 “Preparation on the farm” as an example for the note dialog for controlling the length of the upper links of the rear hitch 11 analogous to FIG. 25.

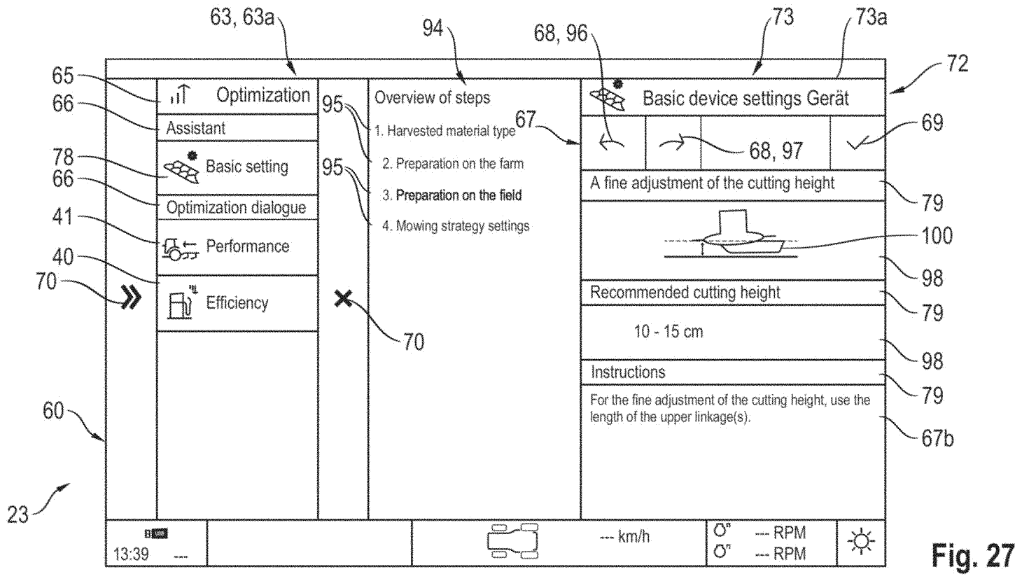

FIG. 27 shows the selected settings step 95 “Preparation of the field” as an example for a dialog for the fine setting of the cutting height that was set at an earlier time in the preceding setting step 95 “Preparation on the farm.”

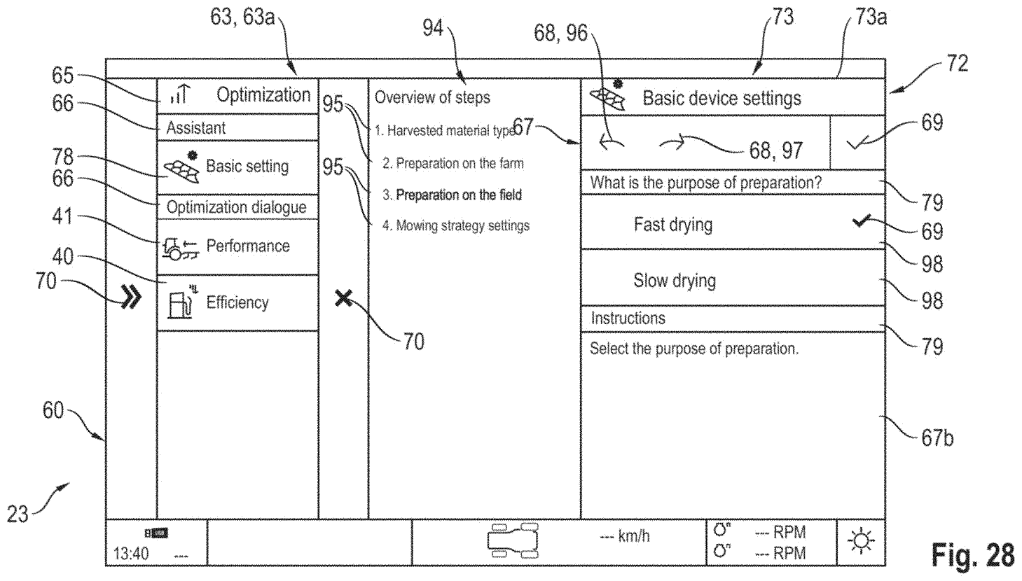

FIG. 28 shows the selected setting step 95 “Mowing strategy settings” and associated selection and setting options that are depicted and selectable in the display segments 98. Accordingly for example in the dialog field 79, the operator 39 is asked about the purpose of processing, provided that corresponding additional equipment 7 is on the disk mower(s) 3, 4. If there is no such additional equipment 7, the corresponding dialog is also omitted. In the subsequent display segments 98, the selection and setting options are depicted; in this case for example the options “Fast drying” or “Slow drying”. The selection made by the operator 37 is visually highlighted and identified as selected and active by the setting option 69.

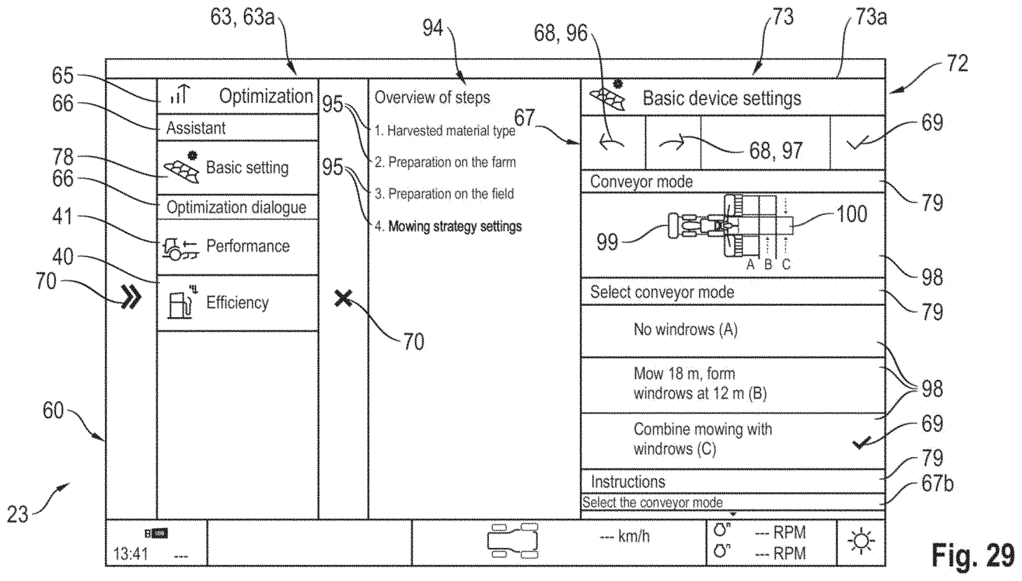

FIG. 29 shows another dialog query for the selected setting step 95 “Mowing strategy settings”. In the dialog field 79, the operator 39 is asked about the mode of operation of the transverse conveyors 9 on the rear disk mowers 4 provided that they exist. In this case as well, the possible modes of operation of the transverse conveyors 9 are visually explained using graphic depictions 99, 100 as well as descriptive instructions corresponding thereto in the dialog fields 79 and the associated display segments 98.

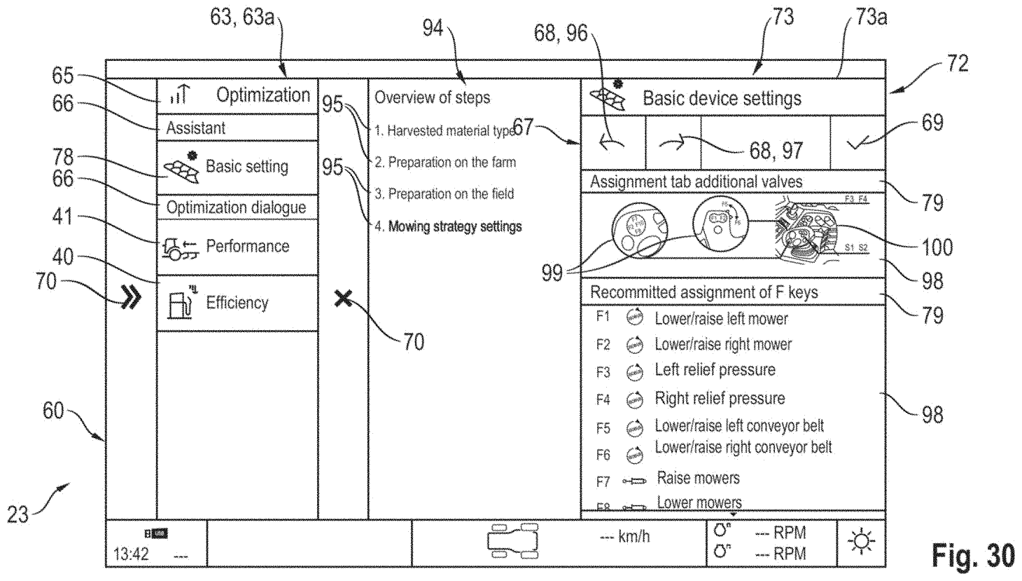

FIG. 30 shows another dialog query for the selected setting step 95 “Mowing strategy settings”. This dialog query addresses the setting and activation of an assignment of functions for operating elements to be actuated manually, in particular function keys, of an operating device of the agricultural work machine 2 designed as a multifunctional lever for the at least one disk mower 3, 4. Recommended assignments of the function keys are provided for selection that are depicted or described in a dialog field 79 of the associated display segment 98. The text explanation of the assignment is also visually supported in this case by graphic depictions 99, 100 in another display segment 98.

The “Strategy” module 38 according to FIG. 4 also includes the natural language, dialog-based determination of setting parameters 49 to be set and/or selected that are determined by the driver assistance system 21. The operating and display unit 23 identically serves to visualize the natural language dialog for determining and adjusting the setting parameter(s) 49 to be set and/or selected. Founded on the basic setting of the specific agriculture machine assembly 1 that was determined by executing the individual modules 39a, 39b, 39c of the “Setting” module 39, setting parameters 49 are proposed that are to be adapted in the “Strategy” module 38 depending on the selectable strategies 40, 41, 42, 43, 43a, 44.

To accomplish this, the driver assistance system 21 asks the purpose of the use of the additional equipment 7 during the specified use of additional equipment 7 in the form of a tine conditioner or a roller conditioner, as well as adjustable guide plates additionally arranged on the at least one disk mower 3, 4, pivotable swathing disks and/or driven conveyor drums. This equally also holds true for disk mowers 3, 4 without additional equipment in the form of a tine conditioner or a roller conditioner, wherein pivotable swathing disks may be arranged on the disk mowers 3, 4 that serve to evenly distribute the mowed material over the work width of the disk mower 3, 4. This may also be a component of the individual module 39c “Work goal”.

An additional query within the “Strategy” module 38 may be linked to a target mode of operation to be selected for the swath deposition. This may also be a component of the individual module 39c “Work goal”. The possible target modes of operation for swath deposition are visualized by the operating and display unit 23 and provide for selection to the operator 37 depending on the number, arrangement and size of the disk mower(s) 3, 4 on the agricultural work machine 2. The presence of at least one transverse conveyor 9 may also be taken into account that influences the number of feasible target modes of operation of swath deposition. In one or some embodiments, the operator 37, when selecting the target mode of operation for swath deposition, may be helped with additional instructions on the advantages and disadvantages of the particular target mode of operation in the decision-making process that are displayed by the operating and display unit 23 in context with the available target mode of operation for swath deposition.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | | | |
|---|---|---|---|
| 1 | Machine assembly | 32 | List of rules |
| 2 | Work machine | 33 | List of rules |
| 3 | Disk mower | 34 | Work aggregate |
| 4 | Disk mower | 35 | Sensor system |
| 5 | Cutting unit | 36 | Control signal |
| 6 | Mowing bar | 37 | Operator |
| 7 | Additional equipment | 38 | “Strategy” module |
| 8 | Swath | 39 | “Settings” module |
| 9 | Transverse conveyor | 39a | “Machine data” individual module |
| 10 | Hitch | 39b | “Basic settings” individual module |
| 11 | Hitch | 39c | “Work goal” individual module |
| 11a | Upper links | 40 | “Efficiency” strategy |
| 11b | Lower links | 41 | “Performance” strategy |
| 12 | Front axle | 42 | “Quality” strategy |
| 13 | Rear axle | 43 | “Soil protection” strategy |
| 14 | Front wheels | 43a | “Cost” strategy |
| 15 | Rear wheels | 44 | “User-defined” strategy |
| 16 | Drive motor | 45 | Device-specific operating parameter |
| 17 | Gearbox | 46 | Manufacturer-specific basic data set |
| 18 | PTO shaft | 47 | User-specific basic data set |
| 19 | Control apparatus | 48 | Device-specific machine parameter |
| 20 | Operating and display unit | 49 | Adjusting parameter |
| 21 | Driver assistance system | 50 | Database |
| 22 | Computing unit | 50a | Attachment database |
| 23 | Operating and display unit | 50b | Tire database |
| 24 | Internal information | 51 | Method step |
| 25 | External information | 52 | Method step |
| 26 | Saveable information | 52a | Method step |
| 27 | Data processing device | 53 | Method step |
| 28 | Control apparatus | 54 | Method step |
| 29 | Work assembly | 55a | Method step |
| 30 | Agricultural work machine setting device | 55 | Method step |
| 31 | Disk mower setting device | 56 | Method step |
| 31a | Common setting device | 57 | Method step |
| 58 | Method step | 79 | Dialog field |
| 58a | Method step | 80 | Pictogram/icon |
| 58b | Method step | 81 | Section |
| 59 | Method step | 82 | Section |
| 60 | First operating and display level | 83 | Section |
| 61 | Visualization area | 84 | Display field |
| 61a | Main menu level | 85 | Marker |
| 62a | Menu level | 86 | Pictogram/icon |
| 63 | Visualization area | 87 | Symbol |
| 63a | Submenu level | 88 | Selection option |
| 64 | Main menu level | 89 | setting option |
| 65 | Menu item | 90 | Setting option |
| 66 | Submenu item | 91 | Pictogram/icon |
| 67 | Ribbon | 92 | Pictogram/icon |
| 67a | Display section | 93 | Additional field |
| 67b | Information field | 94 | Segment |
| 68 | Selection option | 95 | Setting step |
| 69 | setting option | 96 | Directional arrow |
| 70 | Operating option | 97 | Directional arrow |
| 71 | Selection indicator | 98 | Display segment |
| 72 | Second operating and display level | 99 | Graphical depiction |
| 73a | Setting and visualization area | 100 | Graphical depiction |
| 80 | Context field | 101 | Processor |
| 74 | Deletion option | 102 | Memory |
| 75 | Pictogram/icon | AM | Automatic mode |
| 76 | Pictogram/icon | DM | Dialog mode |
| 77 | Pictogram/icon | FR | Direction of travel |
| 78 | Assistant | I_{An} | Output signal |
| | | I_{En} | Input signal |

1. An agriculture machine assembly for use with at least one agricultural work machine that has controllable work aggregates for adjusting setting parameters of the at least one agricultural work machine, and a disk mower including an interface to communicate with the at least one agricultural work machine, the agriculture machine assembly comprising:
a driver assistance system comprising at least one memory configured to store information, at least one operating and display unit, and at least one computing unit;
wherein the at least one computing unit is configured to process information generated by machine-internal sensor systems resident on the at least one agricultural work machine, external information generated external to the at least one agricultural work machine, and the information stored in the at least one memory;
wherein one or both of the at least one agricultural work machine or the disk mower comprise a control device for controlling and regulating a respective one or both of the at least one agricultural work machine or the disk mower;
wherein the driver assistance system comprises an agricultural work machine setting device and a disk mower setting device; and
wherein the agricultural work machine setting device and the disk mower setting device are configured to control operation of the at least one agricultural work machine to generate a controlled state of the at least one agricultural work machine and to control operation of the disk mower to generate a controlled state of the disk mower such that the controlled operation to generate the controlled state of the at least one agricultural work machine and the controlled state of the disk mower are selected dependent on one another.

2. The agriculture machine assembly of claim 1, wherein the agricultural work machine setting device and the disk mower setting device form a common setting device;
wherein the common setting device includes a common set of rules; and
wherein the common setting device, using the common set of rules, is configured to determine the controlled operation for generating the controlled state of the at least one agricultural work machine and the controlled state of the disk mower.

3. The agriculture machine assembly of claim 2, wherein the common setting device is configured to determine the controlled operation in order to optimize a combination of the operation of the at least one agricultural work machine and the operation of the disk mower.

4. The agriculture machine assembly of claim 1, wherein the agricultural work machine setting device and the disk mower setting device form separate devices;
wherein the agricultural work machine setting device includes an agricultural work machine set of rules to determine the controlled operation for generating the controlled state of the at least one agricultural work machine; and
wherein the disk mower setting device includes a disk mower set of rules to determine the controlled operation for generating the controlled state of the disk mower.

5. The agriculture machine assembly of claim 1, wherein the control device for controlling and regulating the disk mower is separate from the agricultural work machine setting device and the disk mower setting device.

6. The agriculture machine assembly of claim 1, wherein the control device for controlling and regulating the disk mower comprises a hydraulic valve assembly of the at least one agricultural work machine and forms part of the agricultural work machine setting device and the disk mower setting device.

7. The agriculture machine assembly of claim 1, further comprising a control apparatus configured as a job computer and assigned to the disk mower; and
wherein the driver assistance system is configured to control the disk mower by sending commands to the control apparatus.

8. The agriculture machine assembly of claim 1, wherein the driver assistance system is further configured to:
receive input as to a selected strategy; and
responsive to receiving the input, select the selected strategy from a plurality of potential strategies to optimize a mode of operation of the agriculture machine assembly.

9. The agriculture machine assembly of claim 8, wherein the plurality of potential strategies comprise at least one of efficiency, performance, quality, soil protection, or cost; and
wherein responsive to receiving the input indicative of selecting efficiency, the agricultural work machine setting device and the disk mower setting device are configured to control operation of the at least one agricultural work machine and the disk mower in order to optimize the efficiency of the combination of the at least one agricultural work machine and the disk mower.

10. The agriculture machine assembly of claim 1, wherein the driver assistance system is configured for a dialog-based determination of setting parameters that are used to optimize a mode of operation of the agriculture machine assembly;
wherein the driver assistance system is configured to determine at least one setting parameter prior to beginning a mowing process in which the disk mower is used;
wherein the at least one setting parameter comprises one or more of: type of the disk mower; position and means for arranging the disk mower on the agricultural work machine; additional equipment on the disk mower; and
wherein the agricultural work machine setting device and the disk mower setting device are configured to optimize operation, in combination and dependent on one another, of the at one agricultural work machine and the disk mower based on the at least one setting parameter.

11. The agriculture machine assembly of claim 1, wherein the driver assistance system is configured to determine at least one setting parameter prior to beginning a mowing process in which the disk mower is used;
wherein the at least one setting parameter comprises one or more of ballast, tire pressure, tire geometry, axle load, relief force of a relieving device, or hitch setting parameter; and
wherein the agricultural work machine setting device and the disk mower setting device are configured to optimize operation, in combination and dependent on one another, of the at one agricultural work machine and the disk mower based on the at least one setting parameter.

12. The agriculture machine assembly of claim 1, wherein the driver assistance system is configured to determine at least one setting parameter prior to beginning a mowing process in which the disk mower is used;
wherein the at least one setting parameter comprises one or more of drive rotational speed of at least one driveshaft of the agricultural work machine, hitch setting parameter, type of attachment device for indirectly or directly adapting to the agricultural work machine, parameter of the disk mower, cutting height, relief force of a relief device, soil distance of a soil contour adaptation device, or coupling distance to the agricultural work machine; and
wherein the agricultural work machine setting device and the disk mower setting device are configured to optimize operation, in combination and dependent on one another, of the at one agricultural work machine and the disk mower based on the at least one setting parameter.

13. The agriculture machine assembly of claim 1, wherein the agricultural work machine is configured to be connected to a plurality of disk mowers;
wherein the driver assistance system is configured to determine one or more overlapping areas of work widths of the plurality of disk mowers to be set; and
wherein the agricultural work machine setting device and the disk mower setting device are configured to optimize operation, in combination and dependent on one another, of the at one agricultural work machine and the disk mower based on the one or more overlapping areas of the work widths of the plurality of disk mowers.

14. The agriculture machine assembly of claim 13, wherein the driver assistance system is configured to determine the one or more overlapping areas of the work widths of the plurality of disk mowers to be set depending on type and position of arrangement of a front and at least one rear disk mower on the agricultural work machine.

15. The agriculture machine assembly of claim 1, further comprising at least one sensor system assigned to the agriculture machine assembly and configured to autonomously determine one or more setting parameters of one or more of the agriculture machine assembly, harvested material parameters or environmental parameters; and
wherein the agricultural work machine setting device and the disk mower setting device are configured to optimize operation, in combination and dependent on one another, of the at one agricultural work machine and the disk mower based on the one or more setting parameters.

16. The agriculture machine assembly of claim 1, wherein the driver assistance system is configured to receive external information in order to determine one or more of setting parameters, harvested material parameters, or environmental parameters; and
wherein the agricultural work machine setting device and the disk mower setting device are configured to optimize operation, in combination and dependent on one another, of the at one agricultural work machine and the disk mower based on the one or more of setting parameters, harvested material parameters, or environmental parameters.

17. The agriculture machine assembly of claim 1, wherein the at least one computing unit includes a functional model of the agricultural work machine and the disk mower, the functional model depicts at least part of a functional relationships of the agricultural work machine and the disk mower adapted thereto; and
wherein the agricultural work machine setting device and the disk mower setting device are configured to optimize operation, in combination and dependent on one another, of the at one agricultural work machine and the disk mower using the functional model.

18. The agriculture machine assembly of claim 17, wherein the functional model, configured to depict the functional relationships of the agriculture machine assembly, comprises at least one n-dimensional characteristic diagram assigned to at least one setting parameter of one or both of the agricultural work machine or the disk mower; and
wherein the at least one setting parameter is defined as an output variable of the at least one n-dimensional characteristic diagram.

19. The agriculture machine assembly of claim 18, wherein at least one or more setting parameters of the agricultural work machine, the disk mower or environmental parameters resulting from environmental conditions form one or more input variables of the at least one n-dimensional characteristic diagram.

20. The agriculture machine assembly of claim 1, wherein the driver assistance system is configured to visualize, using at least one operating and display unit, an operating process for adjusting a setting parameter to be adapted for optimizing a mode of operation of the agriculture machine assembly.
